(19) United States
(12) Patent Application Publication
(10) Pub. No.: US 2013/0013439 A1
(43) Pub. Date: Jan. 10, 2013

(54) Collective Purchase Management System

(76) Inventors: Richard Adam Smullen, New York, NY (US); Martin Desmond Smullen, New York, NY (US)

(21) Appl. No.: 13/541,747

(22) Filed: Jul. 4, 2012

Related U.S. Application Data
(60) Provisional application No. 61/504,808, filed on Jul. 6, 2011.

(51) Int. Cl. G06Q 30/08

(52) U.S. Cl. 705/26.3

(57) ABSTRACT

A computer implemented method and system for managing a collective purchase of a sale item in an interactive environment, provides a reverse auction management platform to buyers and sellers. A lead buyer selects a sale item via a graphical user interface of the reverse auction management platform and initiates a deal. The reverse auction management platform acquires deal information and a price range for the selected sale item from the lead buyer and creates a deal group for the selected sale item. The reverse auction management platform finalizes the deal based on deal finalization criteria and initiates bidding among the sellers of the selected sale item based on the deal information, the price range, and the finalized deal, to select one or more sellers based on the bidding and/or predetermined seller selection criteria for supplying the selected sale item to the deal group for a price within the price range.

### CROSS REFERENCE TO RELATED APPLICATIONS

This application claims the benefit of provisional patent application No. 61/504,808 titled “Management Of Collective Purchase Of A Sale Item”, filed on Jul. 6, 2011 in the United States Patent and Trademark Office.

The specification of the above referenced patent application is incorporated herein by reference in its entirety.

### BACKGROUND

The computer implemented method and system disclosed herein, in general, relates to purchase of a sale item. More particularly, the computer implemented method and system disclosed herein relates to managing a reverse auction for collective purchase of a sale item in an interactive environment.

An auction, for example, a forward auction, a reverse auction, etc., is a process of buying and selling products or services by referencing a set of rules for exchange. The forward auction is used by sellers to sell items to potential buyers. The sale items in a forward auction are generally placed at a special site for the auction. In the forward auction, buyers compete and place bids to purchase a sale item they are interested in and the bid price for the sale item typically increases over time as the bidding at the forward auction proceeds. The buyers continuously bid for the sale item and eventually the highest bidder obtains the sale item.

The reverse auction is an auction where multiple sellers bid to sell their products or services, and prices typically decrease over time as the reverse auction proceeds. The buyers are then provided with an option to select the seller offering the lowest price for a product or a service. Thus, in a reverse auction, the seller offering the lowest unique bid wins the auction. The role of the buyer and seller are reversed in the reverse auction, the primary intention of the reverse auction being to reduce the purchase price of the sale item.

In paper based auctions or bidding processes, and other static bidding processes, the reduction in the purchase price of a sale item is not rapid. Moreover, traditional bidding processes involve high operating costs. Furthermore, the traditional bidding processes typically favor the sellers, thereby compelling the buyers to select the sale item from a single seller. Furthermore, traditional methods of auctioning limit access of a buyer to the sellers who can converge to a common location and time at which the auctions are conducted. Furthermore, when a buyer makes a purchase in a large quantity he/she can typically receive a better price than a purchase in a small quantity. Therefore, there is a need for creating a group of buyers who are interested in a particular sale item to allow them to seek the best deal from the sellers.

Hence, there is a long felt but unresolved need for a computer implemented method and system that facilitates and manages a collective purchase of a sale item in an interactive environment and that allows for a flexible, transparent bidding process that provides a fair opportunity to both the buyers and the sellers to achieve a reasonable bargain.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The computer implemented method and system disclosed herein address the above stated need for facilitating and managing a collective purchase of a sale item in an interactive environment. As used herein, the term “interactive environment” refers a networked environment that allows multiple buyers and sellers to interact for enabling the collective purchase of the sale item. The computer implemented method and system disclosed herein allow for a flexible, transparent bidding process that provides a fair opportunity to both the buyers and the sellers to achieve a reasonable bargain. The computer implemented method and system disclosed herein also addresses the need for an online platform that provides an open phase time interval for prospective buyers to join a deal group for the collective purchase of the sale item over the open phase time interval, after the end of which, referred to as the closed phase, one or more sellers can bid to sell or supply the sale item over a predetermined bidding interval. Furthermore, allowing collective purchase of a sale item improves the possibility of providing a fair price for the sale item to each of multiple buyers while providing an opportunity for a seller to sell a large quantity of the sale item to multiple buyers on a single platform.

A computer implemented method and system for managing a collective purchase of a sale item, for example, a product or a service, in an interactive environment is provided. As used herein, the term “collective purchase” refers to a purchase of a sale item by each buyer of a group of buyers, that intends to buy the sale item from one or more sellers under a set of terms and conditions defined by a lead buyer of the group, where one or more sellers supply the sale item under the defined terms and conditions to the group of buyers either individually or through a lead seller. As used herein, the term “lead buyer” refers to a buyer who selects a sale item for collective purchase, initiates a deal for the selected sale item, and provides a price range, for example, a minimum price and a maximum price for the selected sale item, deal information such as terms and conditions for the collective purchase of the selected sale item, etc., on the reverse auction management platform. The computer implemented method and system disclosed herein provides a reverse auction management platform comprising at least one processor configured to manage the collective purchase of the sale item in the interactive environment. The reverse auction management platform is accessible by a computing device of each of multiple buyers and sellers in the interactive environment over a network.

The reverse auction management platform allows a lead buyer from among multiple buyers to select a sale item from multiple sale items displayed on the reverse auction management platform via a graphical user interface (GUI) provided by the reverse auction management platform. The reverse auction management platform allows the lead buyer to initiate a deal for the selected sale item on the reverse auction management platform via the GUI. As used herein, the term “deal” refers to a transaction including a bid process initiated by the lead buyer for the collective purchase of the selected sale item from one or more sellers of the selected sale item based on conditional criteria defined by the lead buyer. The reverse auction management platform acquires deal information and a price range for the selected sale item from the lead buyer via the GUI on initiation of the deal. The deal information comprises, for example, an open phase time interval, an open phase expiration date, an open phase expiration time, a date and a time for delivery of the selected sale item to the lead buyer and following buyers in the deal group, conditional criteria, etc., defined by the lead buyer via the GUI. As used herein, the “open phase” refers to a time interval during which buyers other than the lead buyer, referred herein as “following buyers”, agree to purchase the selected sale item in accordance with conditional criteria defined by the lead buyer for the collective purchase of the selected sale item. The acquired price range comprises a minimum price and a maximum price for the selected sale item. In an embodiment, the lead buyer defines the price range for the selected sale item on the GUI of the reverse auction management platform based on an agreement by one or more sellers of the selected sale item to supply the selected sale item for a price within the price range defined by the lead buyer. In an embodiment, the reverse auction management platform selects the price range for the deal group based on a price range associated with one or more prior transactions involving the same or similar type of the selected sale item.

The reverse auction management platform creates a deal group for the selected sale item based on the acquired deal information and the acquired price range. The deal group comprises the lead buyer and one or more following buyers. The following buyers are the buyers who agree to the deal information and the price range defined by the lead buyer for the selected sale item. In an embodiment, the reverse auction management platform generates and transmits invitations to one or more prospective following buyers associated with the lead buyer on one or more social networking platforms via the network, for joining the deal group. The reverse auction management platform finalizes the initiated deal for the selected sale item based on deal finalization criteria, when the following buyers agree to the deal information and the price range acquired from the lead buyer. The deal finalization criteria comprise, for example, one or more of a completion of an open phase time interval during which one or more following buyers agree to purchase the selected sale item in accordance with conditional criteria defined by the lead buyer for the collective purchase of the selected sale item, reaching of a maximum number of following buyers allowed in the deal group, etc. The deal finalization criteria are metrics which determine when a deal can move to the bidding phase. In an embodiment, the bidding phase for bidding on the selected sale item among the sellers initiates after the open phase.

In an embodiment, the reverse auction management platform provides a withdrawal interface element on the GUI for allowing the lead buyer and/or any of the following buyers in the deal group to withdraw from the deal group during the open phase time interval. In an embodiment, the reverse auction management platform determines a penalty for withdrawal of the lead buyer and/or any of the following buyers from the deal group after expiration of the open phase. In an embodiment, the reverse auction management platform does not permit withdrawal from the deal group after the expiration of the open phase. In another embodiment, the reverse auction management platform may allow withdrawal from the deal group after the expiration of the open phase, provided the withdrawing buyer forfeits the entire price of the sale item.

In an embodiment, the reverse auction management platform acquires and validates sale transaction information from the lead buyer and each of the following buyers in the deal group at initiation of the open phase, during the open phase, and a point in time at expiration of the open phase via the GUI, for facilitating the collective purchase of the selected sale item. In an embodiment, the reverse auction management platform removes one or more of the following buyers from the deal group, if those following buyers have not provided valid sale transaction information to the reverse auction management platform prior to the expiration of the open phase. Furthermore, in an embodiment, the reverse auction management platform obtains a legally binding confirmation from the lead buyer and each of the following buyers in the deal group regarding the collective purchase of the selected sale item prior to expiration of the open phase, via the GUI.

The reverse auction management platform transmits a notification to each of the sellers of the selected sale item, the lead buyer, and each of the following buyers in the deal group regarding the finalized deal for the selected sale item via the network. The sellers who are notified also include, for example, sellers who have previously requested to be notified when a deal for a product in a particular product category has been finalized. The reverse auction management platform initiates bidding on the selected sale item among the sellers of the selected sale item in the interactive environment based on the acquired deal information, the acquired price range for the selected sale item, and the finalized deal. The reverse auction management platform initiates a bidding interval for the bidding on the selected sale item among the sellers of the selected sale item after the completion of the open phase.

The reverse auction management platform selects one or more sellers based on the bidding and/or predetermined seller selection criteria for selling and supplying the selected sale item to the lead buyer and each of the following buyers in the deal group for a price within the acquired price range. The predetermined seller selection criteria ensure, for example, selection of the seller who agrees to supply the selected sale item to the lead buyer and each of the following buyers in the deal group at the lowest price at the end of the bidding interval. In another example, the predetermined seller selection criteria allow selection of the seller who first offers the minimum price defined by the lead buyer at the initiation of the open phase. In another example, predetermined seller selection criteria allow selection of the seller who offers a price within the price range defined by the lead buyer and who first agrees to provide warranty terms equal to or better than a predefined threshold set of terms defined by the lead buyer. In an embodiment, the reverse auction management platform terminates the bidding on the selected sale item when any of the sellers of the selected sale item agrees to supply the selected sale item to the lead buyer and each of the following buyers in the deal group at the minimum price of the selected sale item.

In an embodiment, the reverse auction management platform allows the lead buyer to modify the deal information for the selected sale item for facilitating renewed bidding on the selected sale item by the sellers of the selected sale item in the interactive environment on failure of the initiated bidding. The reverse auction management platform acquires the modifications to the deal information and/or the price range for the selected sale item from the lead buyer via the GUI of the reverse auction management platform for facilitating the renewed bidding on the selected sale item by the sellers of the selected sale item in the interactive environment. In another embodiment, the reverse auction management platform defines conflict resolution criteria agreeable to the lead buyers and each of the following buyers in the deal group and the sellers of the selected sale item for resolving conflicts between the lead buyer and each of the following buyers in the deal group and the sellers of the selected sale item.

In an embodiment, the reverse auction management platform generates revenue by charging a predetermined commission from the lead buyer and each of the following buyers in the deal group and each of the selected sellers of the selected sale item after finalization of the initiated deal and the supply of the selected sale item to the lead buyer and each of the following buyers in the deal group.

In an embodiment, the reverse auction management platform transmits advertisement notifications related to sale items in similar item categories associated with the selected sale item or other item categories to the lead buyer, each of the following buyers in the deal group, and other buyers via the network for initiating prospective deals on the reverse auction management platform. The reverse auction management platform thereby manages the collective purchase of the selected sale item by the lead buyer and the following buyers in the deal group from the selected sellers in the interactive environment.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein.

FIG. 1 illustrates a computer implemented method for managing a collective purchase of a sale item in an interactive environment.

FIGS. 2A-2B exemplarily illustrate screenshots of a graphical user interface provided by a reverse auction management platform for introducing a buyer to the reverse auction management platform.

FIG. 3 exemplarily illustrates a screenshot of a graphical user interface provided by the reverse auction management platform for enabling a buyer to select a sale item.

FIGS. 4A-4C exemplarily illustrate screenshots of a graphical user interface provided by the reverse auction management platform for enabling a buyer to initiate a deal for a selected sale item.

FIGS. 5A-5K exemplarily illustrate screenshots of a graphical user interface provided by the reverse auction management platform for managing a collective purchase of a sale item in an interactive environment.

FIG. 6 exemplarily illustrates a computer implemented system for managing a collective purchase of a sale item in an interactive environment.

FIG. 7 exemplarily illustrates the architecture of a computer system employed by the reverse auction management platform for managing a collective purchase of a sale item in an interactive environment.

FIGS. 8A-8B exemplarily illustrate a flowchart comprising the steps performed by the reverse auction management platform for managing a collective purchase of a sale item in an interactive environment.

### DETAILED DESCRIPTION OF THE INVENTION

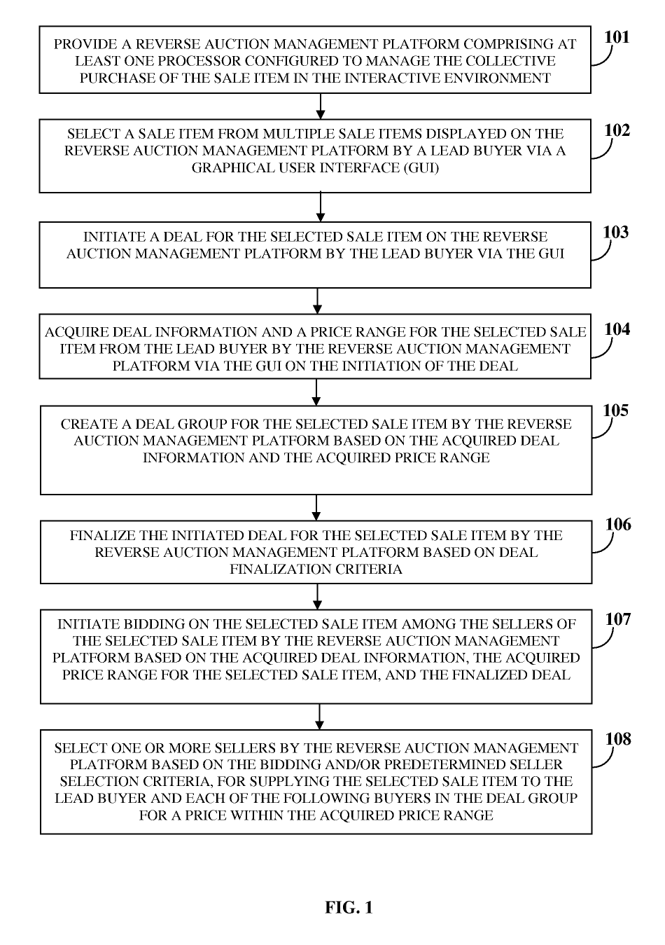

FIG. 1 illustrates a computer implemented method for managing a collective purchase of a sale item in an interactive environment. As used herein, the term “interactive environment” refers to an environment that allows interaction between multiple buyers and sellers via a network, for example, the internet, an intranet, a local area network, a wide area network, a communication network implementing WiFi® of the Wireless Ethernet Compatibility Alliance, Inc., a cellular network, a mobile communication network such as a global system for mobile communications (GSM) network, a general packet radio service (GPRS) network, an interactive television network, etc., for enabling the collective purchase of the sale item. Also, as used herein, the term “collective purchase” refers to a purchase of a sale item by each buyer of a group of buyers, that intends to buy the sale item from one or more sellers under a set of terms and conditions defined by a lead buyer of the group, where one or more sellers supply the sale item under the defined terms and conditions to the group of buyers either individually or through a lead seller. As used herein, the term “sale item” refers to a commodity, for example, information, a product, a service, etc. The term “buyer” refers to a customer, a consumer, an individual, an organization, etc., that wants to purchase a sale item from a seller at a price within a predefined price range. The term “seller” refers to an individual dealer, an outlet, a company, a supplier, etc., that wants to sell a sale item to one or more buyers via a bidding process. Also, as used herein, the term “lead buyer” refers to a buyer who selects a sale item for collective purchase, initiates a deal for the selected sale item, and provides a price range, for example, a minimum price and a maximum price for the selected sale item, deal information such as terms and conditions for the collective purchase of the selected sale item, etc., on the reverse auction management platform.

The computer implemented method disclosed herein provides 101 a reverse auction management platform to multiple buyers and sellers in an interactive environment. The reverse auction management platform comprises at least one processor configured to manage the collective purchase of the sale item in the interactive environment. The reverse auction management platform is, for example, a web platform, a mobile platform, etc. The interactive environment allows interaction between multiple buyers and sellers on the reverse auction management platform via the network. The reverse auction management platform is, for example, hosted on an online server and is configured to facilitate bidding among the sellers for selling a particular sale item to each of the buyers in a deal group, with the bidding starting from a maximum price defined by a lead buyer. The offered sale price is progressively reduced during the process of reverse bidding until a minimum possible price of the price range defined by the lead buyer is reached by one or more sellers, or the predetermined bidding interval expires. The reverse auction management platform selects a particular seller who agrees to sell the sale item at the minimum price reached on completion of the bidding and offers a contract to the seller for supplying the sale item to each of the buyers in the deal group. The reverse auction management platform is accessible by a computing device of each of multiple buyers and sellers in the interactive environment over the network. The computing device is, for example, a mobile communication device, a desktop computer, a laptop computer, etc. The mobile communication device is, for example, a tablet computer, a smart phone, a mobile phone, a gaming console, etc. The reverse auction management platform is accessible, for example, through a wide spectrum of technologies and devices such as general packet radio service (GPRS), 3G or other internet enabled cellular phones and tablet computing devices, computers with connection to the internet, televisions with digital set top boxes, etc.

The reverse auction management platform allows a lead buyer from among the buyers to select 102 a sale item from multiple sale items displayed on the reverse auction management platform via a graphical user interface (GUI) provided by the reverse auction management platform. The sale items comprise, for example, products and/or services associated with a particular company, products and/or services of different companies. The dealers, suppliers, etc., of each of the sale items, who are registered with the reverse auction management platform, qualify as sellers and can take part in bidding for a particular sale item. In an embodiment, the reverse auction management platform displays the sale items as a catalogue on the GUI. The reverse auction management platform creates item descriptions of the sale items not listed in the catalogue. The item description comprises, for example, special features, a prototype, etc., of each of the sale items. In an embodiment, the reverse auction management platform enables a buyer and a seller to register with the reverse auction management platform and create a profile on the reverse auction management platform. The reverse auction management platform creates a unique user account for each of the buyers and the sellers. The user account stores personal information, for example, a login identifier (ID) and a password, type of sale items in which a particular buyer and/or a seller is interested, contact details such as a phone number, a shipping address, banking account information such as a bank account number, etc.

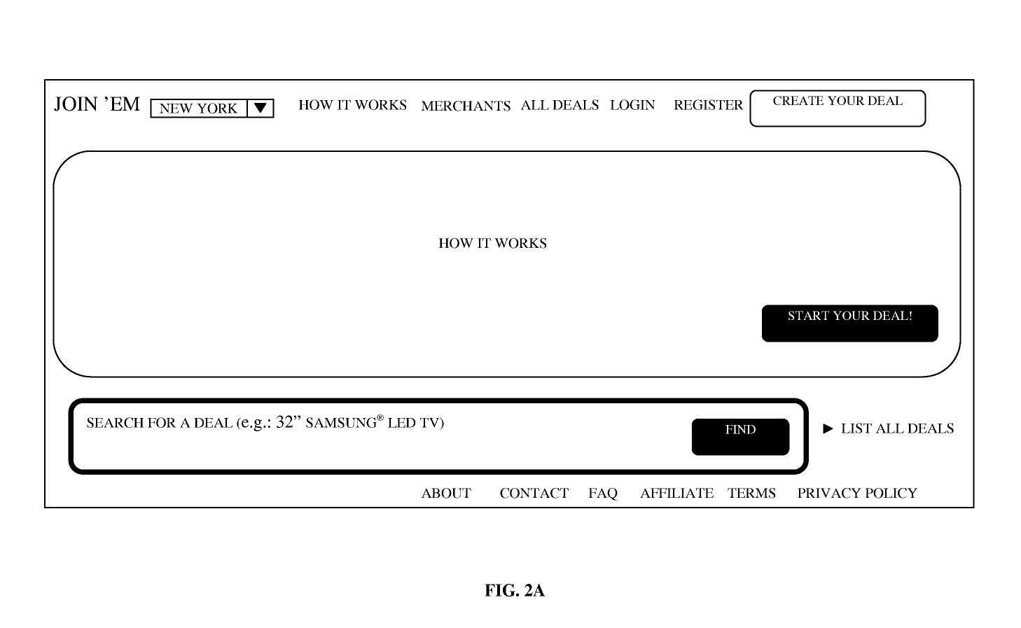

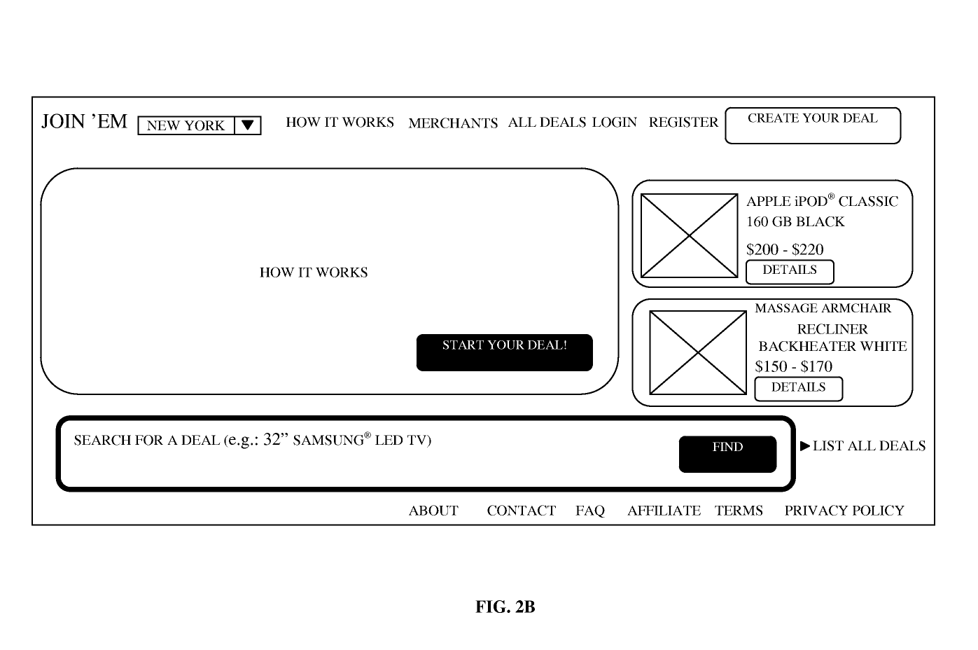

The reverse auction management platform enables the lead buyer to initiate 103 a deal for the selected sale item on the reverse auction management platform via the GUI. As used herein, the term “deal” refers to a transaction including a bid process initiated by the lead buyer for the collective purchase of the selected sale item from one or more sellers of the selected sale item based on conditional criteria defined by the lead buyer. The conditional criteria comprise, for example, terms and conditions defined by the lead buyer for a deal group. As used herein, the term “deal group” refers to a group of buyers assembled by the reverse auction management platform who intend to purchase the selected sale item in accordance with the deal information and price range acquired from the lead buyer. The deal group comprises the lead buyer and one or more following buyers. The lead buyer and the following buyers in the deal group are herein also referred to as “buyers in the deal group”. The following buyers are the buyers who want to purchase the sale item selected by the lead buyer and who agree to the deal information and the price range defined by the lead buyer for the selected sale item. The conditional criteria defined by the lead buyer further comprise, for example, an allowed price range, warranty and after sale service terms for a service or a product, a delivery method, a timeframe for delivery, inclusion of special features or functionalities for certain kinds of products such as shoes or apparel, where the special features include color, size, finish, etc., a commission fee agreed to be paid in advance by each of the buyers in the deal group, etc. In an example, the lead buyer initiates the deal by clicking on a “create your deal” button on the GUI of the reverse auction management platform as exemplarily illustrated in FIGS. 2A-2B, FIG. 3, and FIGS. 5C-5J. In an embodiment, the reverse auction management platform allows the buyer to enter a name, a prototype, a model, etc., of a sale item via the GUI for initiation of a deal on the reverse auction management platform. The reverse auction management platform searches for a match between the details entered by the buyer on the requested sale item and details of all the sale items currently available with the reverse auction management platform. If the sale item is not currently available for auction on the reverse auction management platform, the reverse auction management platform displays a notification message on the GUI informing the buyer that the buyer would be notified via an electronic mail, a short message service (SMS) message, etc., when the requested sale item is available.

The reverse auction management platform acquires 104 deal information and a price range for the selected sale item from the lead buyer via the GUI on initiation of the deal. As used herein, the term “deal information” comprises, for example, an open phase time interval, an open phase expiration date, an open phase expiration time, a date and a time for delivery of the selected sale item to the lead buyer and the following buyers in the deal group, the conditional criteria comprising the terms and conditions defined by the lead buyer, number of units of the selected sale item, a maximum number of following buyers in the deal group, other terms and conditions, etc. As used herein, the term “open phase” refers to a time interval during which one or more buyers other than the lead buyer, referred herein as “following buyers”, agree to purchase the selected sale item in accordance with the conditional criteria defined by the lead buyer for the collective purchase of the selected sale item. Therefore, the reverse auction management platform requires the lead buyer to define a time period during which other prospective following buyers may agree to purchase the selected sale item on the same terms and conditions defined by the lead buyer. This time period where prospective following buyers may agree to a collective purchase of the selected sale item on the terms and conditions defined by the lead buyer is herein referred to as an “open phase”. Consider an example where the lead buyer defines the open phase as a month from the date of initiation of the deal. Therefore, the following buyers who are interested in purchasing the selected sale item in accordance with the conditional criteria defined by the lead buyer may join a deal group led by the lead buyer within the month from the date of initiation of the deal. In an embodiment, the reverse auction management platform automatically sets the open phase for the initiated deal.

The price range acquired from the lead buyer on initiation of the deal comprises a maximum price and a minimum price for the selected sale item. As used herein, the term “maximum price” refers to the maximum price that the lead buyer can offer for the selected sale item and the term “minimum price” refers to the minimum price that the lead buyer deems as a reasonable price for the selected sale item. In an example, in order to acquire the deal information and the price range, the reverse auction management platform prompts the lead buyer via the GUI to provide the lead buyer's personal details, the selected sale item, a price range for the selected sale item, a date of delivery, etc., via the GUI. In an embodiment, the lead buyer also defines a bid expiration date and a bid expiration time for bidding on the selected sale item by the sellers. As used herein, the term “bid expiration date” refers to a date at which bidding is closed on the reverse auction management platform and the term “bid expiration time” refers to a time at which bidding is closed on the reverse auction management platform. In an embodiment, the reverse auction management platform automatically sets the bid expiration date and the bid expiration time for bidding associated with the initiated deal.

In an embodiment, the lead buyer defines the price range for the selected sale item on the GUI of the reverse auction management platform based on an agreement by one or more sellers of the selected sale item to supply the selected sale item for a price within the price range defined by the lead buyer. For example, the lead buyer may need a confirmation from the sellers of the selected sale item that the price at which the selected sale item is sold at completion of the bidding is within a budget allocated for purchasing the selected sale item by the lead buyer. Therefore, the lead buyer may define a price range after receiving an estimate of the price at which the selected sale item is likely to be sold by the sellers of the selected sale item. The lead buyer agrees in advance to purchase the selected sale item on the condition that one or more sellers agree to supply the selected sale item for a price within the price range defined by the lead buyer. In another embodiment, the lead buyer defines a price range based on the lead buyer's expected price range without receiving any confirmation or estimates from the sellers, and agrees to purchase the selected sale item if, subsequently, one of the sellers agrees to sell at a price within the expected price range of the lead buyer. In this embodiment, there exists a possibility that none of the sellers agree to offer the sale item within the expected price range of the lead buyer, thereby resulting in failure of the deal.

In an embodiment, the reverse auction management platform selects the price range for a deal group based on a price range associated with one or more prior transactions involving a same or similar type of the selected sale item. Consider an example where the sale item selected by a lead buyer of a deal group is a music player of a particular brand. Therefore, the type of the selected sale item is, for example, a music player. The reverse auction management platform retrieves a price range associated with a prior round of bidding for the same product or for a music player of a rival brand with similar technical features and pricing and sets the price range for the deal group accordingly.

The reverse auction management platform may reference a price range, a final selling price, etc., for a predetermined number of previous transactions recorded by the reverse auction management platform involving sale of the particular selected sale item during a predetermined duration of time for selecting a price range for the deal group. That is, the reverse auction management platform selects the price range based on a final selling price at which a previous deal was closed. The final selling price refers to a price at which one or more sellers agreed to sell the selected sale item to each of the buyers in a deal group. For example, the reverse auction management platform may reference sale transactions of an electronic gadget during the past 48 hours and extract the price range and final selling price associated with each sale transaction. The reverse auction management platform may set the price range only on determining a stability of the price range and the bidding price, to ensure that abrupt changes in the price range and bidding pattern owing to fluctuations in the market price of the selected sale item are equalized prior to setting the price range for the current deal. In an example, the reverse auction management platform defines the price range for the selected sale item, for example, based on the current market price of the selected sale item, previous deals of the selected sale item, etc.

In an embodiment, the reverse auction management platform sets a price range for a deal group based on a percentage range of the current market price of the selected sale item, for example, using historical discounts achieved on other deals for the same or similar sale items. For example, if the current market price of a sale item is $500, the reverse auction management platform calculates a maximum price of $400 and a minimum price of $250 based on a predetermined percentage range from 20% to 50% below the market price. The reverse auction management platform then recommends the determined price range to the lead buyer in the deal group. The lead buyer can use the recommended price range as a guideline in setting a price range while providing the deal information on initiation of the deal on the reverse auction management platform, thereby ensuring that the price range has a high probability of being matched or lowered by one or more sellers. The lead buyer may set the minimum and maximum price of the price range in accordance with the minimum price and the maximum price recommended by the reverse auction management platform.

In an embodiment, the reverse auction management platform may determine an equilibrium price for the selected sale item by computing a weighted average of the maximum price and the minimum price defined by the lead buyer in the deal group. Furthermore, the reverse auction management platform equalizes the equilibrium price with a predetermined retail price defined for the selected sale item. Consider an example where the minimum price set by the lead buyer as part of the price range, for an electronic gadget sale item, is $350, and the maximum price defined by the lead buyer for the price range is $500. The reverse auction management platform assigns a predetermined weight of 0.5 to the maximum price, and 0.5 to the minimum price. Therefore, the reverse auction management platform determines an equilibrium price equal to $425. Furthermore, the price range defined by the lead buyer may not be viable for the following buyers and sellers of the electronic gadget. For example, suppose that the electronic gadget has been recently released in the market and is priced at $700. The price of the electronic gadget may however drop to about 80% of the initial retail price of $700 over a period of time. The reverse auction management platform notifies the lead buyer that the price range defined by the lead buyer may not be viable in view of the current retail price of the electronic gadget and requests the lead buyer to define a different price range. The reverse auction management platform may accept the price range previously defined by the lead buyer after a predetermined period of time when the retail price of the electronic gadget drops to $560. In another example, in order to achieve a balance between the retail price and the price range defined by the lead buyer, the reverse auction management platform may equalize the offset between the defined price range and the retail price by increasing the minimum price by a predetermined amount. This ensures that the minimum price to be reached by the sellers during bidding is not sufficiently low for the sellers to incur a loss.

After initiation of the deal and acquisition of the deal information and the price range from the lead buyer, the reverse auction management platform creates 105 a deal group for the selected sale item based on the acquired deal information and the acquired price range. The deal group comprises the lead buyer and one or more following buyers. The following buyers are included in the deal group if they agree to the price range, the date and time of delivery of the selected sale item, and other terms and conditions defined by the lead buyer.

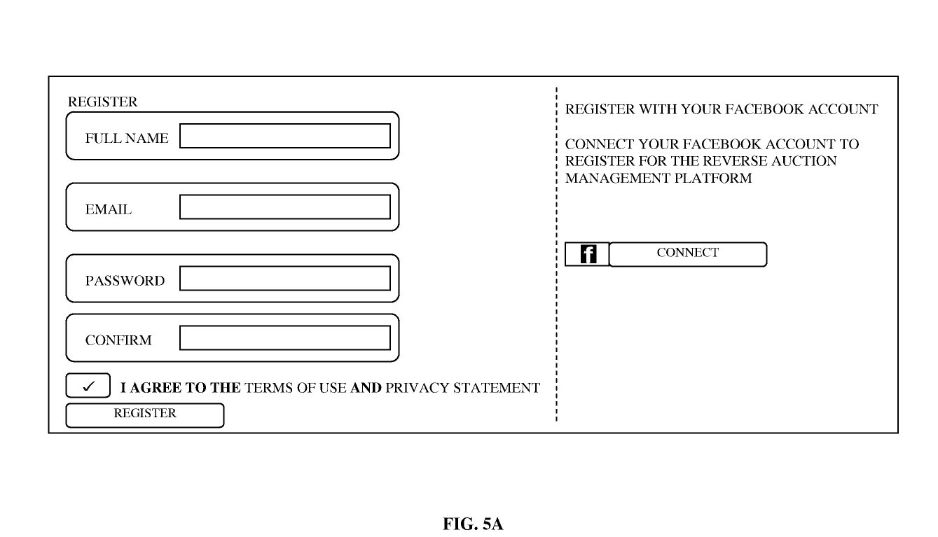

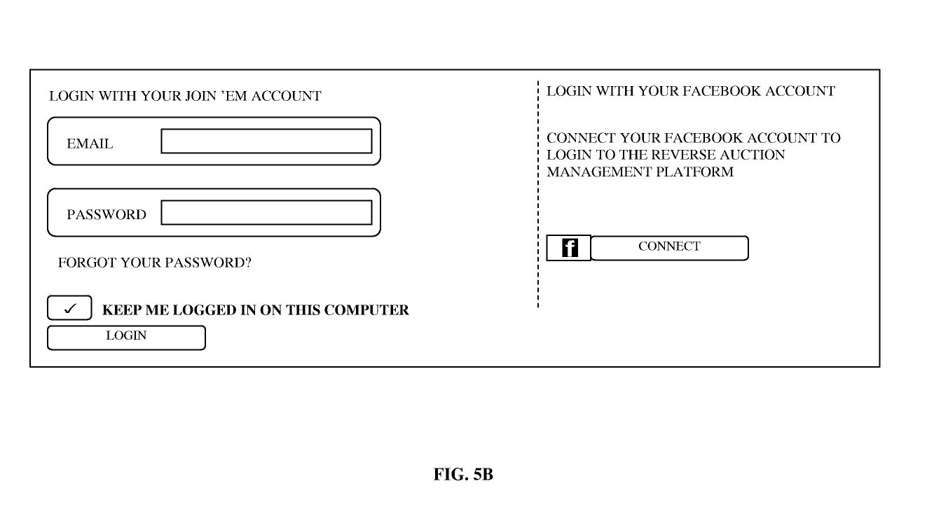

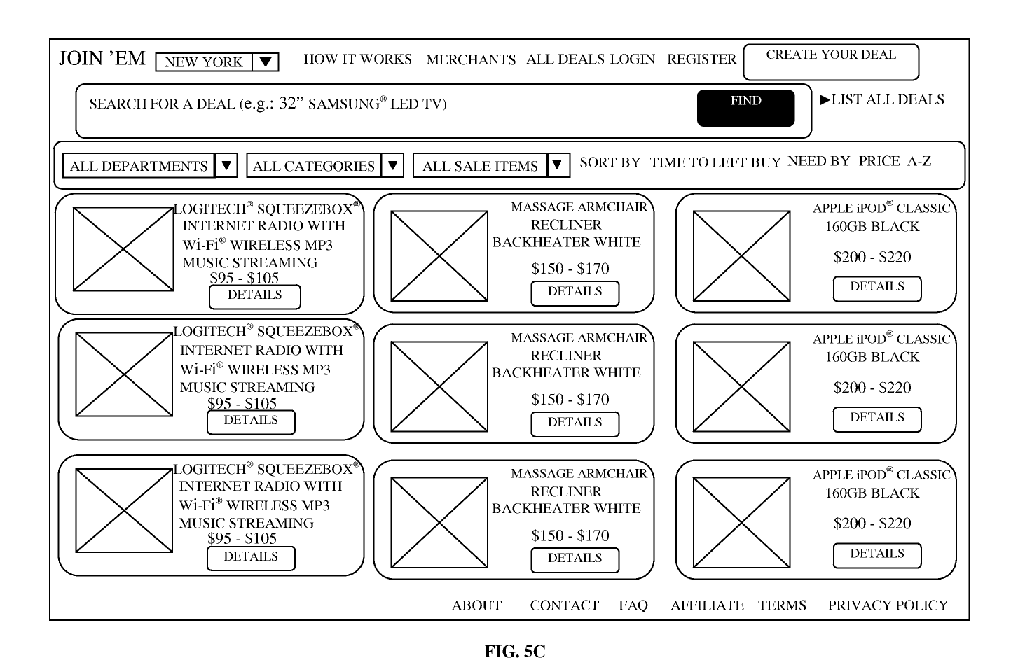

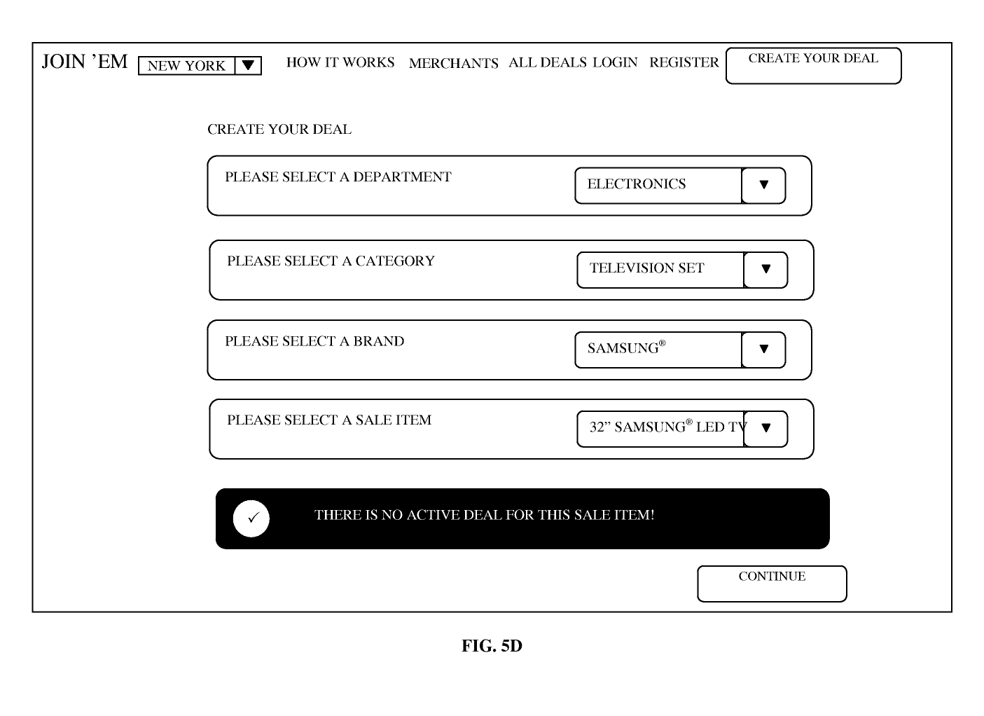

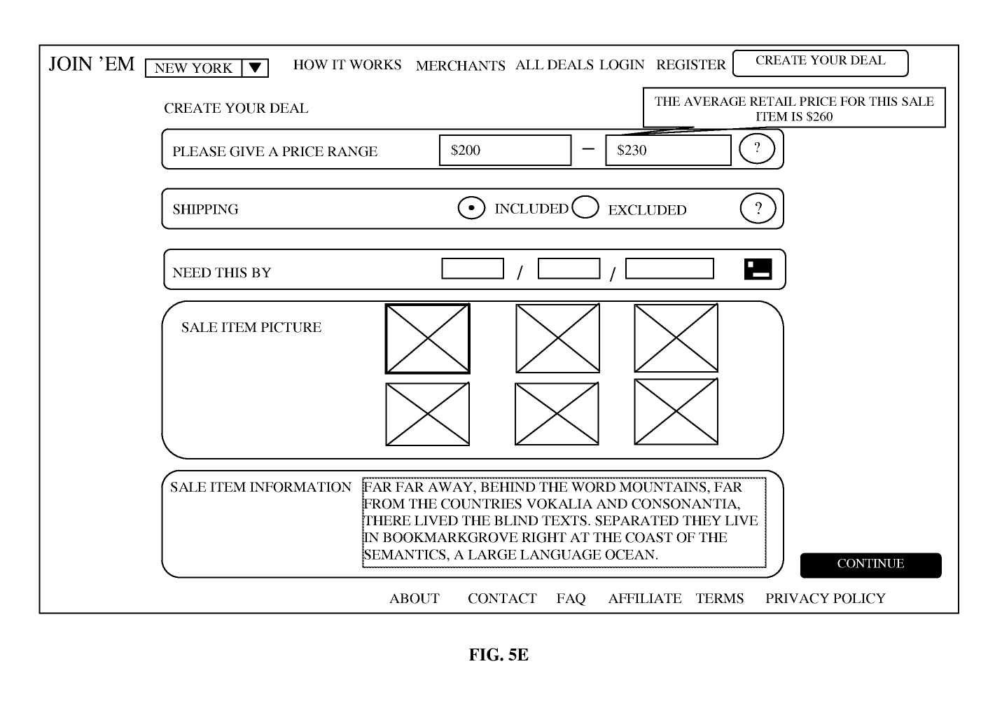

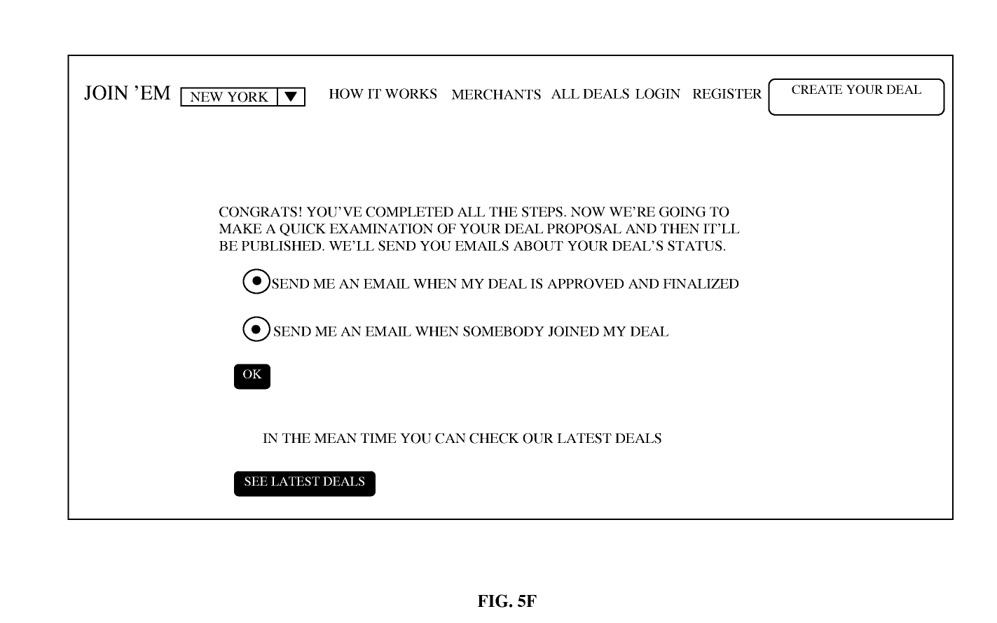

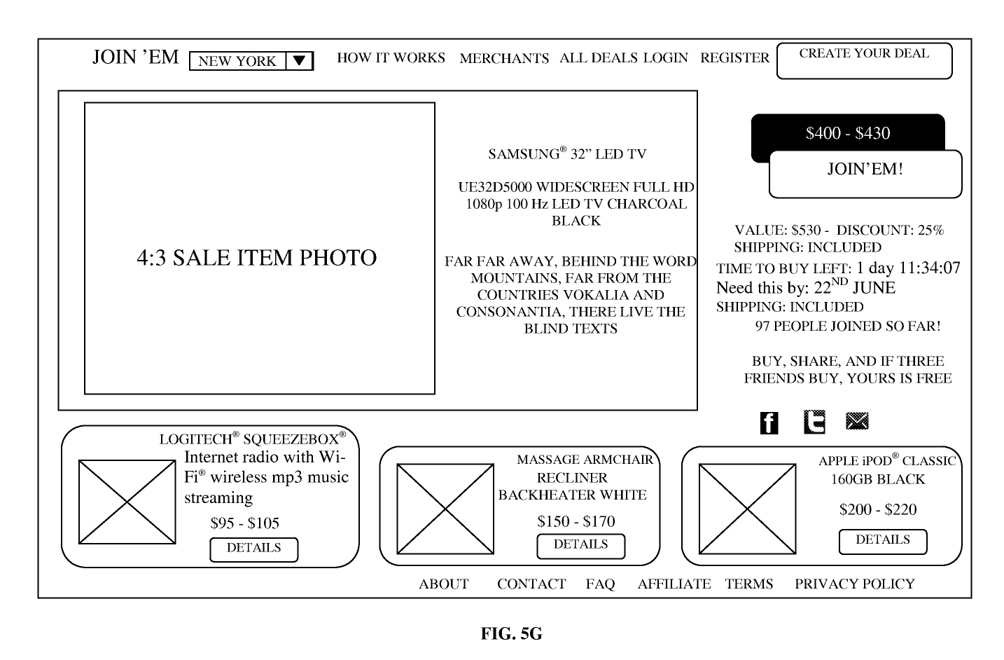

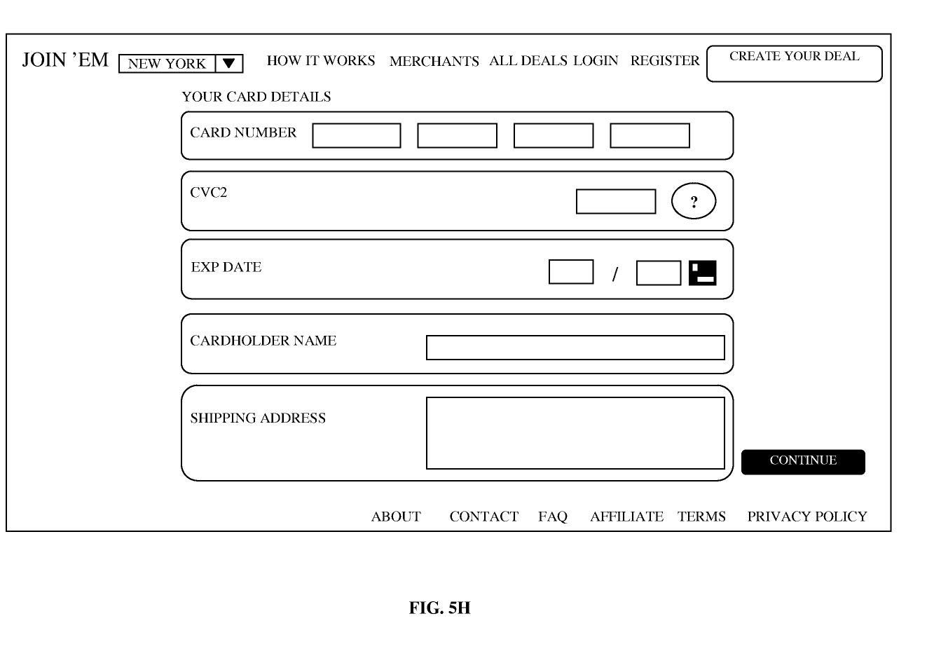

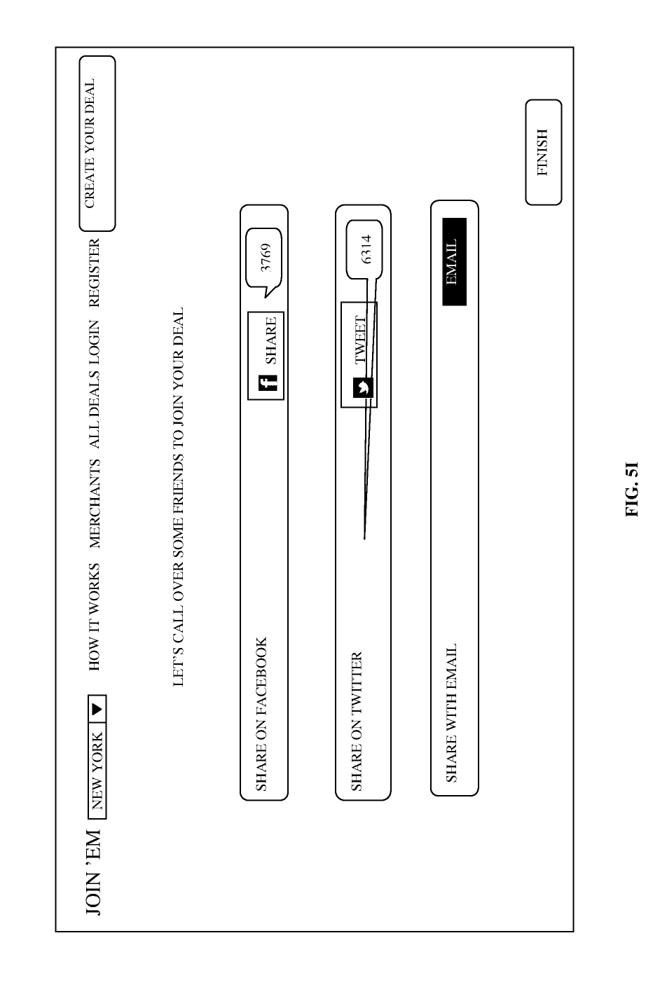

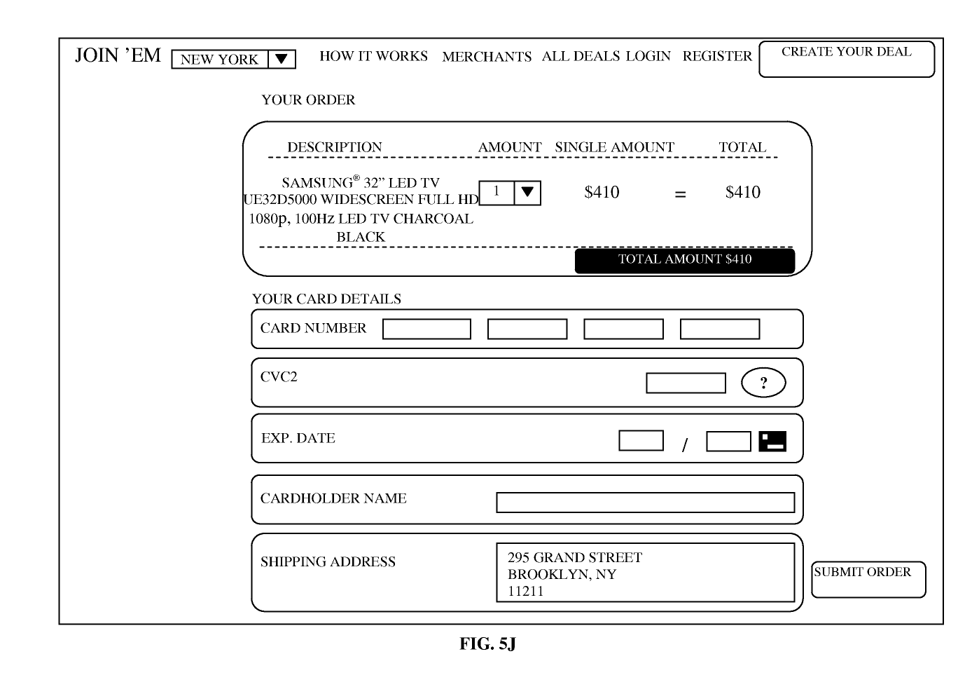

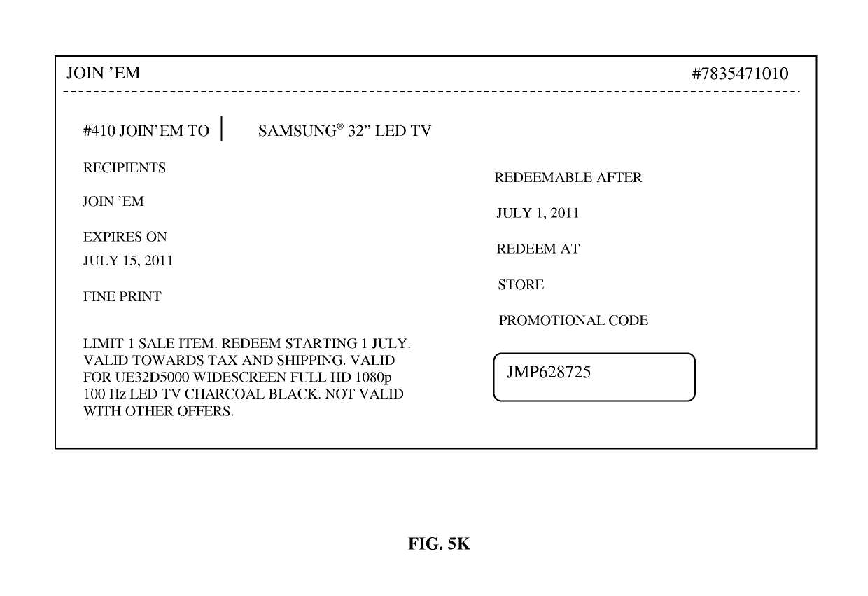

In an embodiment, the reverse auction management platform determines whether a deal has already been initiated for the selected sale item and whether a deal group has already been created for the selected sale item, before enabling the lead buyer to initiate the deal for the selected sale item. If the reverse auction management platform determines that a deal has already been initiated and a deal group has already been created for the selected sale item, then the reverse auction management platform displays the deal information and prompts a buyer to join the deal group as a following buyer, as exemplarily illustrated in FIG. 5G. The reverse auction management platform ensures that the following buyers adhere to the deal information as joining the deal group constitutes a legally binding agreement to purchase the selected sale item based on the deal information acquired from the lead buyer. If the reverse auction management platform determines that a deal group has not been created for the selected sale item, then the reverse auction management platform prompts the buyer to initiate a deal and enable creation of a deal group as a lead buyer, as exemplarily illustrated in FIG. 5D.

In an embodiment, the reverse auction management platform generates and transmits invitations to one or more prospective following buyers associated with the lead buyer on one or more social networking platforms via the network, for joining the deal group. For example, the lead buyer may trigger the generation of the invitations by providing a list of prospective following buyers accessible via a social networking platform, such as Facebook® of Facebook, Inc., who may be interested in purchasing the selected sale item, via the GUI of the reverse auction management platform. The prospective following buyers may be friends or acquaintances of the lead buyer. In an embodiment, the reverse auction management platform allows the lead buyer and the following buyers in the deal group to directly invite interested parties, for example, friends, etc., to join the deal group, via social networking websites, electronic mail (email), etc. Furthermore, the reverse auction management platform allows a lead buyer to share the deal information and the price range on the social networking platform via the network for inviting prospective following buyers interested in the selected sale item to join the deal group. In another embodiment, the reverse auction management platform enters into a collaboration with a social networking platform that allows the reverse auction management platform to automatically transmit a notification on the availability of the selected sale item for bidding, creation of the deal group, the deal information associated with the selected sale item, etc., to fan communities of the selected sale item on the social networking platform.

Furthermore, in an embodiment, the reverse auction management platform facilitates interactions, for example, discussions on bidding strategies, the price range, etc., between the lead buyer and the following buyers, and between the buyers in the deal group and the sellers, on the reverse auction management platform by provisioning a chat based application on the reverse auction management platform. In another example, the reverse auction management platform facilitates interactions between the lead buyer and the following buyers in the deal group on social networking platforms by coordinating invitations, responses to invitations, updates on the open phase, amount of time remaining for expiration of the bidding date and the bidding time, etc.

In an embodiment, the reverse auction management platform provides a withdrawal interface element on the GUI for allowing the lead buyer and/or any of the following buyers in the deal group to withdraw from the deal group during the open phase. For example, a following buyer in the deal group who may not have adequate funds to purchase the selected sale item may wish to withdraw from the deal group. This following buyer can activate the withdrawal interface element, for example, a “withdraw” button on the GUI to exit from the deal group. The reverse auction management platform allows this following buyer to withdraw from the deal group if the withdrawal is performed before the expiration of the open phase. Therefore, the reverse auction management platform allows the lead buyer and/or any of the following buyers in the deal group to withdraw from the deal group at any point of time until the end of the open phase.

In an embodiment, the reverse auction management platform determines a penalty for withdrawal of the lead buyer and/or any of the following buyers from the deal group after expiration of the open phase. For example, the reverse auction management platform may impose a fine on a buyer who withdraws from the deal group after expiration of the open phase, cancel a subscription of the buyer to the reverse auction management platform for a predetermined time period, etc. The reverse auction management platform may transfer the fine amount or a percentage of the fine amount collected from a particular buyer to one or more sellers who have agreed to supply the selected sale item to the buyers in the deal group, to cover possible costs incurred by the sellers who have ordered the selected sale item in advance for the buyers in the deal group. In another embodiment, the reverse auction management platform does not permit withdrawal from the deal group after the expiration of the open phase. In another embodiment, the reverse auction management platform allows withdrawal from the deal group after the expiration of the open phase, provided the buyer forfeits the entire price of the sale item.

In an embodiment, the reverse auction management platform acquires and validates sale transaction information from the lead buyer and each of the following buyers in the deal group at a point in time at initiation of an open phase, a point in time during the open phase, or a point in time at expiration of the open phase via the GUI, for facilitating the collective purchase of the selected sale item. The sale transaction information comprises, for example, payment transaction information and shipment address information. The payment transaction information comprises information on a mode of payment from the buyers in the deal group such as credit card details, bank account details, check details, etc., and may include a predefined advance payment to be made for purchasing the selected sale item, etc. The reverse auction management platform manages payments for the purchase of the selected sale item using the payment transaction information. The shipment address information is acquired by the reverse auction management platform via the GUI from the buyers in the deal group for delivering the selected sale item to each of the buyers in the deal group who purchased the selected sale item. The shipment address information comprises, for example, a contact number, an electronic mail (email) address, a shipping address for delivery of the selected sale item, etc.

Furthermore, in an embodiment, the reverse auction management platform obtains a legally binding confirmation from the lead buyer and each of the following buyers in the deal group regarding the collective purchase of the selected sale item prior to expiration of the open phase, via the GUI. The reverse auction management platform notifies the buyers in the deal group shortly before the end of the open phase and requires each of the buyers in the deal group to confirm before the end of the open phase that they are committing in a legally binding way to purchase the selected sale item if one or more sellers agree to the terms, including the price range, defined by the lead buyer. The reverse auction management platform, at the time of obtaining the legally binding confirmation, also acquires payment details from the buyers in the deal group or allows the buyers in the deal group to select from previously provided payment information, if not already provided or selected, to be used to pay for the purchase of the selected sale item, and also acquires shipping address information if not already provided. In an embodiment, the reverse auction management platform obtains a payment authorization from each buyer in the deal group before expiration of the open phase and before the deal is made available to one or more sellers, for ensuring that the resulting purchase price amount can be obtained from each buyer in the deal group if a seller who intends to fulfill the deal is identified by the reverse auction management platform. Therefore, the reverse auction management platform confirms prior to the end of the open phase that each of the buyers in the deal group is legally committed to purchase the selected sale item if one or more sellers agree to the deal information and the price range during a subsequent bidding interval. As used herein, the term “bidding interval” refers to a time interval that commences after the expiration of the open phase time interval, during which sellers bid to supply the selected sale item to the buyers in the deal group. Therefore, the sellers bid only after the buyers in the deal group agree to the deal information and the price range.

After creation of the deal group comprising the lead buyer and one or more following buyers, the reverse auction management platform finalizes 106 the initiated deal for the selected sale item based on deal finalization criteria, when the following buyers agree to the deal information and the price range acquired from the lead buyer. The deal finalization criteria comprise, for example, one or more of a completion of an open phase time interval during which one or more following buyers agree to purchase the selected sale item in accordance with conditional criteria defined by the lead buyer for the collective purchase of the selected sale item, reaching of a maximum number of following buyers allowed in the deal group, or any other metrics which determine when the initiated deal can move from the open phase to the auction or bidding phase, etc.

In an embodiment, the reverse auction management platform finalizes the initiated deal on confirming the validity of the sale transaction information provided by each of the buyers in the deal group. On confirming the validity of the sale transaction information of each buyer in the deal group, the reverse auction management platform moves the deal from the open phase to a closed phase. The closed phase of the deal indicates that the deal has been finalized, that each of the buyers in the deal group are eligible to receive the selected sale item as part of the collective purchase of the selected sale item, and that no more buyers are to be added to the deal group. The reverse auction management platform determines the validity of the payment transaction information prior to the end of the open phase. The reverse auction management platform, for example, determines the validity of the information provided by a buyer for the mode of payment selected by the buyer. The information for the mode of payment to be used by a buyer to remit the purchase amount is herein referred to as “payment mode information”. The reverse auction management platform performs an authorization transaction using the payment mode information received from each of the buyers in the deal group, via a payment processing service provider to confirm that the payment mode information is valid. If the buyer does not provide valid payment transaction information before the end of the open phase, or if the payment mode information is found to be invalid on performing the authorization transaction, the reverse auction management platform removes the buyer associated with the invalid payment transaction information or the invalid payment mode information from the deal group before initiating bidding on the deal by the sellers.

In another embodiment, the reverse auction management platform compiles a range of bids from sellers, where each seller agrees to sell a certain number of units of the selected sale item at a certain price. The reverse auction management platform may then fulfill the deal group by taking all the units from the lowest price offers, then the units from the next lowest offer, and so on, until the entire number of units required for the deal is met.

In an embodiment, the reverse auction management platform finalizes the initiated deal when the number of buyers in the deal group reaches the maximum number of buyers as defined in the deal information acquired from the lead buyer by the reverse auction management platform. The reverse auction management platform then terminates inclusion of additional following buyers to the deal group and notifies the sellers about the finalized deal for the selected sale item. In an example, the reverse auction management platform finalizes the deal when the total number of buyers in the deal group reaches forty. In an embodiment, the reverse auction management platform finalizes the initiated deal after expiry of the time duration defined in the deal finalization criteria by the reverse auction management platform.

The reverse auction management platform transmits a notification to each of the sellers of the selected sale item, the lead buyer, and each of the following buyers in the deal group regarding the finalized deal for the selected sale item via the network. For example, the reverse auction management platform automatically transmits a notification regarding the finalized deal for the selected sale item to the buyers in the deal group and the sellers via email, short message service (SMS) messages, etc.

After finalization of the initiated deal, the reverse auction management platform initiates 107 bidding on the selected sale item among the sellers of the selected sale item in the interactive environment based on the acquired deal information, the acquired price range for the selected sale item, and the finalized deal. The reverse auction management platform initiates a bidding interval for bidding on the selected sale item among the sellers of the selected sale item after completion of the open phase. In an embodiment, the bidding interval initiates subsequent to the open phase during which the following buyers agree to purchase the selected sale item in accordance with conditional criteria defined by the lead buyer for the collective purchase of the selected sale item. Therefore, the sellers begin bidding for supplying the selected sale item to the buyers in the deal group only after all the following buyers, or a minimum number of the following buyers if specified by the reverse auction management platform, have agreed to the terms and conditions and the price range defined by the lead buyer. The reverse auction management platform terminates the bidding on the selected sale item when any of the sellers of the selected sale item agrees to supply the selected sale item to the lead buyer and each of the following buyers in the deal group at the minimum price of the selected sale item defined by the lead buyer.

In an embodiment, the reverse auction management platform conducts the bidding based on a Dutch auction model, in which a minimum price is raised until a seller accepts the lead buyer's price or until the lead buyer's maximum price is reached. That is, the reverse auction management platform provides the minimum price defined in the deal information for the selected sale item as a starting price to the sellers. The reverse auction management platform initiates bidding with the minimum price and the reverse auction management platform gradually raises the price, by fixed increments, for example, by fixed percentages of the starting price until either a seller agrees to the price or a predetermined maximum price is reached. The predetermined maximum price is, for example, the maximum price in the price range defined in the deal information by the lead buyer, a maximum price recommended by the reverse auction management platform, a maximum price acceptable to the sellers, etc.

The reverse auction management platform selects 108 one or more sellers based on the bidding and/or predetermined seller selection criteria for selling and supplying the selected sale item to the lead buyer and each of the following buyers in the deal group for a price within the acquired price range. The predetermined seller selection criteria comprise, for example, an agreement by one or more sellers to supply the selected sale item to the lead buyer and each of the following buyers in the deal group. In an embodiment, the reverse auction management platform selects a seller who offers a bid equal to a minimum price defined in the deal information by the lead buyer before the bid expiration date and the bid expiration time, for selling the selected sale item. In another embodiment, the reverse auction management platform selects the seller who offers the lowest price at completion of the bid expiration date and the bid expiration time for selling the selected sale item. In another embodiment, the reverse auction management platform selects the seller based on a quality and condition of the selected sale item offered by the seller. In an embodiment, the predetermined seller selection criteria allow selection of the seller who first offers the minimum price defined by the lead buyer at the initiation of the open phase. In another embodiment, the predetermined seller selection criteria allow selection of the seller who offers a price within the price range defined by the lead buyer and who first agrees to provide warranty terms equal to or better than some threshold set of terms defined by the lead buyer.

In an embodiment, the reverse auction management platform transmits a notification to the lead buyer if the maximum price defined in the price range is not reached by the sellers during the bidding process. This may result in a potential deadlock between the buyers of the deal group and the sellers and a potential failure of the initiated bidding. Failure of the initiated bidding occurs, for example, when none of the sellers agree to bid within the price range defined in the deal information by the lead buyer, when none of the participating sellers agree to deliver the selected sale item by the delivery date defined by the lead buyer, etc. The reverse auction management platform prompts the lead buyer of the deal group to modify the deal information and the price range for the selected sale item via the GUI. The reverse auction management platform acquires modifications to the deal information and/or the price range for the selected sale item from the lead buyer via the GUI of the reverse auction management platform for facilitating a renewed bidding on the selected sale item by the sellers of the selected sale item in the interactive environment, on failure of the initiated bidding. In an example, on receiving approval from the following buyers in the lead group, the lead buyer increases the maximum price in the price range for the selected sale item until one of the sellers makes a bid offer. In another example, the lead buyer prompted by the reverse auction management platform extends the bid expiration time to allow a better time margin for the sellers to deliver the selected sale item to the buyers in the deal group.

In another embodiment, the reverse auction management platform forwards the notification to modify the deal information to the deal group. The buyers in the deal group collectively come to an understanding on the necessary modification of the deal information and the price range and forward the modified deal information and the price range to the reverse auction management platform via the network, to be forwarded in turn to the sellers of the selected sale item. The reverse auction management platform then renews the bidding process based on the modified deal information and the modified price range.

In an embodiment, the reverse auction management platform transmits notifications to sellers who have not been offered the deal but whose bids are within a fixed percentage of the final bid for a separate bidding process with “late buyers”, that is, buyers who have registered with the reverse auction management platform after the deal was finalized. In another embodiment, the reverse auction management platform transmits notifications to sellers whose bids are within a fixed percentage of the final bid for a renewed bidding process if the seller who was selected to supply the sale item withdraws from the deal or backs out of the deal. In another embodiment, the reverse auction management platform offers the deal to the seller who offers the next lowest price after the defined minimum price of the original finalized deal.

In an embodiment, the reverse auction management platform allows the lead buyer to modify the price range for the selected sale item, for example, when bidding is initiated, that is, when a first seller makes a bid offer, or during the entire bidding process until the bidding is closed. The lead buyer can modify the price range, for example, by increasing the minimum price in the price range till the maximum price in the price range is reached. In another example, the lead buyer decreases the minimum price for the sale item and if a seller agrees to the decreased minimum price, the reverse auction management platform selects that seller to sell and supply the selected sale item at the decreased minimum price to each of the buyers in the deal group.

In an embodiment, the reverse auction management platform controls the modification of the price range for the selected sale item by the lead buyer. The reverse auction management platform allows the lead buyer, for example, to lower the minimum price or increase the minimum price till the maximum price defined in the deal information is reached. In another embodiment, the reverse auction management platform allows the lead buyer to lower the maximum price but does not allow the lead buyer to increase the maximum price as the following buyers in the deal group have agreed to the maximum price defined in the deal information, and increasing the maximum price further requires approval from all the following buyers in the deal group. In an embodiment, the reverse auction management platform terminates the deal, for example, when none of the sellers agree to the price range on completion of the bid expiration date and the bid expiration time, and transmits a notification message to the lead buyer and the following buyers informing them of the termination of the initiated deal.

In an embodiment, the reverse auction management platform defines conflict resolution criteria agreeable to the lead buyer and each of the following buyers in the deal group and the sellers of the selected sale item for resolving conflicts between the lead buyer and each of the following buyers in the deal group and the sellers of the selected sale item. For example, the reverse auction management platform applies conflict resolution criteria to select a seller to sell the selected sale item to the buyers in the deal group, when more than one seller offers the same price at the bid expiration date and the bid expiration time. The conflict resolution criteria comprise, for example, number of units of the selected sale item offered by the seller for a particular price, geographical proximity of the seller to the buyers in the deal group, etc. In an example, if more than one seller offers the same price for a selected sale item, the reverse auction management platform selects the seller who offers the maximum number of units of the selected sale item to the buyers in the deal group for the same price. In another example, the reverse auction management platform selects the seller who is geographically the closest to a majority of the buyers in the deal group. In another embodiment, the reverse auction management platform conducts a poll among the buyers in the deal group for selecting the seller. For example, the reverse auction management platform selects the seller who receives the maximum number of votes in the conducted poll.

In an embodiment, the reverse auction management platform selects multiple sellers when more than one seller agrees to sell the selected sale item for the same price at the bid expiration date and the bid expiration time. The reverse auction management platform then provides an option to the buyers in the deal group to purchase the selected sale item from any one or more of the selected sellers. In an embodiment, the reverse auction management platform enables multiple sellers to form a consortium, collaborate, and collectively deliver the selected sale item in accordance with the deal information to each of the buyers in the deal group. For example, a consortium of sellers can collaborate and collectively deliver the total number of units of the selected sale item requested by the buyers in the deal group. The reverse auction management platform thereby allows sellers who are not in a position to deliver the required number of units of the selected sale item individually, to form a consortium, collaborate, and collectively deliver the required number of units of the selected sale item to each of the buyers in the deal group. In another example, the consortium of sellers can collaborate and collectively sell the selected sale item requested by the buyers in the deal group at a price within the price range defined by the lead buyer based on a selected or winning seller's bid. In an embodiment, a lead seller controls the consortium of sellers and manages the collaboration and collective sale and delivery of the required number of units of the selected sale item to each of the buyers in the deal group. In an embodiment, the reverse auction management platform distributes an aggregate amount collected from all the buyers in the deal group to the sellers in the consortium upon closure of the deal in accordance with a percentage share of the number of units of the selected sale item delivered by each of the sellers.

In an embodiment, the reverse auction management platform generates revenue by charging a predetermined commission from the lead buyer and each of the following buyers in the deal group and each of the selected sellers of the selected sale item on finalization of the initiated deal and supply of the selected sale item to the lead buyer and each of the following buyers in the deal group. For example, the reverse auction management platform charges a commission from each of the buyers in the deal group when a selected sale item is supplied to each of the buyers in the deal group. In another example, the reverse auction management platform charges a commission from each of the sellers each time the sellers are selected for supplying the selected sale item to each of the buyers in the deal group. In another example, the reverse auction management platform charges a commission from each of the buyers in the deal group and each of the sellers participating in the bidding, on closure of the deal between the buyers in the deal group and the selected sellers. The reverse auction management platform charges a fixed percentage of the total deal amount paid by the buyers in the deal group to the sellers as a commission.

In an embodiment, the reverse auction management platform transmits advertisement notifications related to sale items in similar item categories associated with the selected sale item or other item categories to the lead buyer, each of the following buyers in the deal group, and other buyers via the network for initiating prospective deals on the reverse auction management platform. In another embodiment, the reverse auction management platform transmits notifications on supplementary sale items associated with the selected sale item, to the lead buyer, each of the following buyers in the deal group, and other buyers via the network for initiating another deal on the reverse auction management platform. A supplementary sale item is, for example, a sale item similar to the selected sale item that was sold to each of the buyers of the deal group in terms of a brand, a type of product such as a particular type of a smart phone, a price range associated with the sale item, etc. In an example, when a particular sale item is added to a catalogue of sale items and is available for a reverse auction based sale, the reverse auction management platform searches for a similar already auctioned sale item. The reverse auction management platform verifies whether the sale item is associated with a particular brand, and has a price range and technical features or specifications similar to the already auctioned sale item. The reverse auction management platform tracks the buyers who purchased the sale item during the last transaction and transmits notifications to these buyers stating that a similar item is available for purchase and that a deal could be initiated by any of the buyers on the reverse auction management platform. The reverse auction management platform thereby manages the collective purchase of the selected sale item by the lead buyer and the following buyers in the deal group from the selected sellers in the interactive environment.

FIGS. 2A-2B exemplarily illustrate screenshots of a graphical user interface (GUI) provided by the reverse auction management platform for introducing a buyer to the reverse auction management platform. Consider an example where a buyer approaches the reverse auction management platform. The reverse auction management platform provides an introduction of the reverse auction management platform to the buyer, for example, via a “how it works” link on the GUI as exemplarily illustrated in FIG. 2A. On clicking on the “how it works” link, the reverse auction management platform takes the buyer through the steps of initiating a deal and performing a collective purchase on the reverse auction management platform. For example, the reverse auction management platform enables the buyer to get a practical insight into the working of the reverse auction management platform by allowing the buyer to initiate a mock process, that is, a process that simulates the collective purchase process. The reverse auction management platform also provides a search bar on the GUI as exemplarily illustrated in FIG. 2A, that enables the buyer to search for a sale item, for example, a 32 inch Samsung® light emitting diode (LED) television (TV) set. In an embodiment, the reverse auction management platform also displays deal information and price ranges of sale items for which deal groups have been created on the GUI as exemplarily illustrated in FIG. 2B.

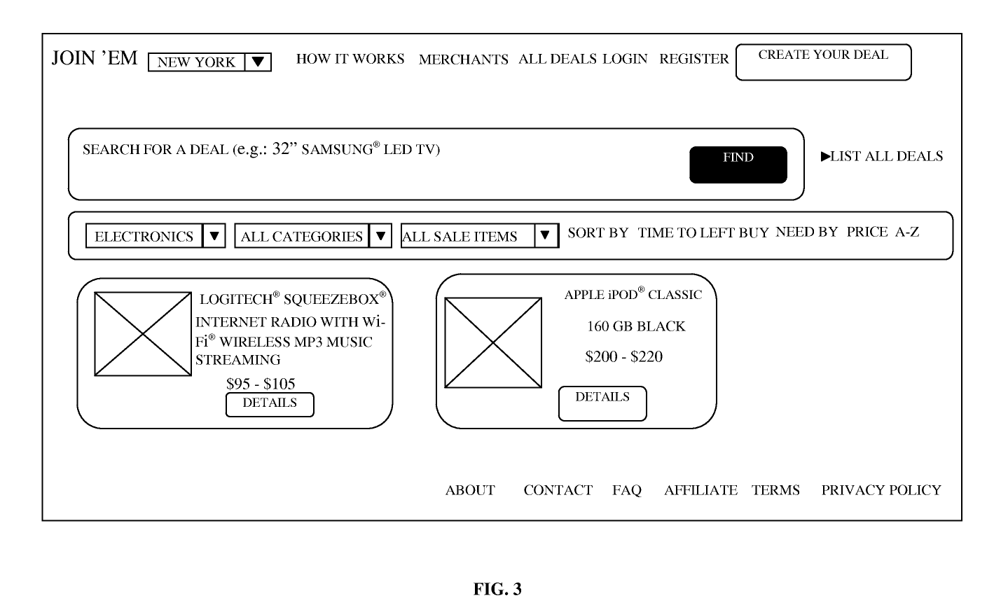

FIG. 3 exemplarily illustrates a screenshot of a graphical user interface (GUI) provided by the reverse auction management platform for enabling a buyer to select a sale item. The reverse auction management platform provides a search bar on the GUI that allows the buyer to search for a sale item. The reverse auction management platform also allows the buyer to directly input the sale item that the buyer wants to purchase. The reverse auction management platform also provides drop down menus on the GUI to aid the buyer in selecting the sale item. The dropdown menus comprise, for example, department, category, brand, name, etc., of the sale item.

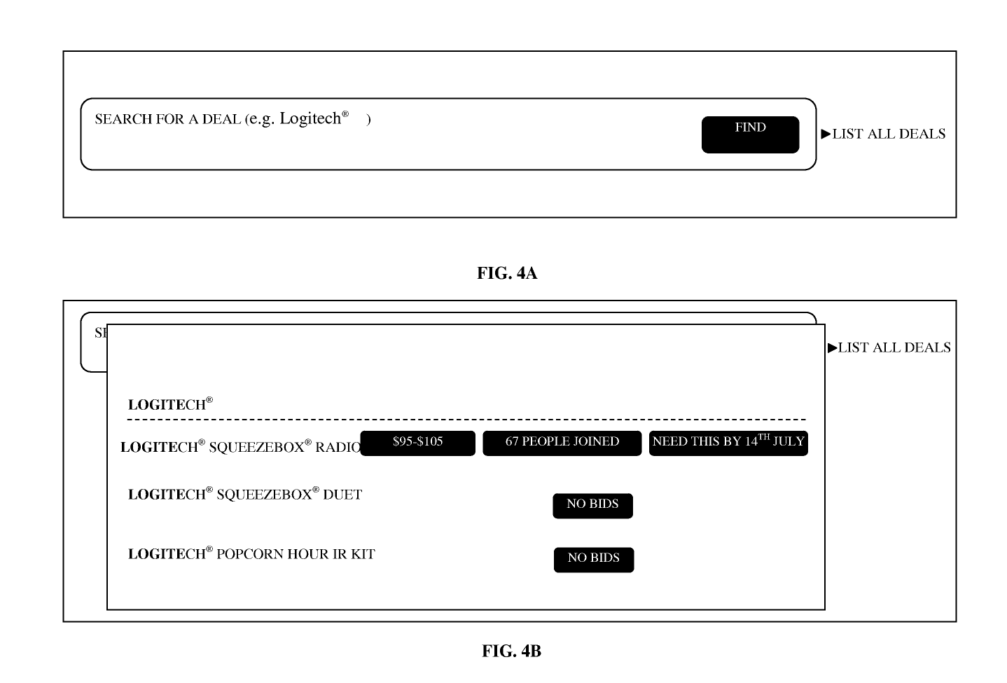

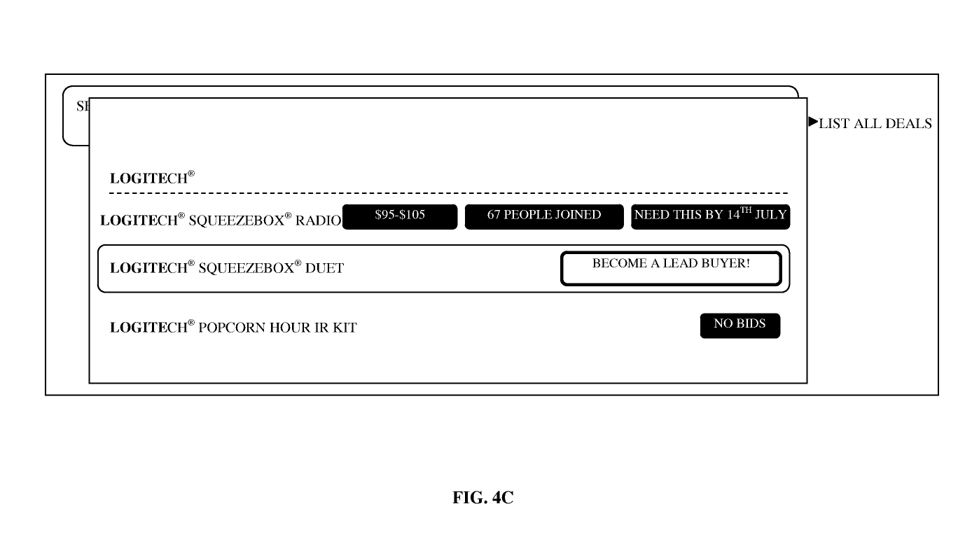

FIGS. 4A-4C exemplarily illustrate screenshots of a graphical user interface (GUI) provided by the reverse auction management platform for enabling a buyer to initiate a deal for a selected sale item. Consider an example where the buyer wants to purchase a Logitech® Squeezebox® Duet music system. The buyer searches for the Logitech® Squeezebox® Duet music system by typing a keyword on a search bar provided on the GUI of the reverse auction management platform as exemplarily illustrated in FIG. 4A. The reverse auction management platform retrieves a list of sale items from Logitech, Inc., from an information database of the reverse auction management platform and displays a catalogue of all the sale items of Logitech, Inc., for example, a Logitech® Squeezebox™ radio system, a Logitech Squeezebox™ Duet music system, and a Logitech® Popcorn Hour internet radio (IR) kit on the GUI as exemplarily illustrated in FIG. 4B. The reverse auction management platform indicates to the buyer if a deal has been initiated and a deal group has been created for each of the sale items in the catalogue. The reverse auction management platform also displays the deal information and the price range for each of the sale items for which a deal has already been created. In this example, the reverse auction management platform indicates that a deal group has been created for the Logitech® Squeezebox® radio system and displays the deal information and the price range alongside the name of the sale item as exemplarily illustrated in FIGS. 4B-4C. The reverse auction management platform indicates that no deal has been initiated for the Logitech® Squeezebox® Duet music system and the Logitech® Popcorn Hour internet radio (IR) kit as exemplarily illustrated in FIG. 4B. The reverse auction management platform prompts the buyer to initiate the deal for the Logitech® Squeezebox® Duet music system as a lead buyer, as exemplarily illustrated in FIG. 4C. On clicking the prompt link for the Logitech® Squeezebox® Duet music system, the buyer becomes the lead buyer for a deal group to be created for the Logitech® Squeezebox® Duet music system.

FIGS. 5A-5K exemplarily illustrate screenshots of a graphical user interface (GUI) provided by the reverse auction management platform for managing a collective purchase of a sale item in an interactive environment. Consider an example where the reverse auction management platform manages a collective purchase of a sale item, for example, a 32 inch Samsung® light emitting diode (LED) television (TV) set of Samsung Corporation, in an interactive environment. A buyer interested in purchasing the Samsung® LED TV accesses the reverse auction management platform using an internet enabled tablet computing device via a network, for example, the internet. The reverse auction management platform enables the buyer to register with the reverse auction management platform via the GUI as exemplarily illustrated in FIG. 5A. The reverse auction management platform acquires, for example, the buyer's full name, electronic mail (email) address, and password via the GUI. The reverse auction management platform registers the buyer on the reverse auction management platform once the buyer agrees to the terms and conditions of the reverse auction management platform. In an embodiment, the reverse auction management platform provides an option to the buyer to register with the reverse auction management platform via a third party account, for example, a Facebook® account as exemplarily illustrated in FIG. 5A. On registration, the reverse auction management platform enables the buyer to log in to the reverse auction management platform using the account created by the reverse auction management platform on registration or using the third party account, as exemplarily illustrated in FIG. 5B.

The reverse auction management platform displays multiple sale items along with their deal information and price ranges in a catalogue on the GUI and also provides a search bar that enables the buyer to search for the Samsung® LED TV as exemplarily illustrated in FIG. 5C. The reverse auction management platform then determines whether a deal has been initiated and a deal group created for the Samsung® LED TV. In this example, the reverse auction management platform determines that no deal has been initiated and no deal group has been created for the Samsung® LED TV. The buyer can then initiate a deal as a lead buyer and create a deal group for the Samsung® LED TV by clicking on a “create your deal” link provided on the GUI as exemplarily illustrated in FIGS. 5C-5D. The lead buyer provides deal information, for example, by selecting a department, a category, a brand, a product, etc., for the Samsung® LED TV on the GUI as exemplarily illustrated in FIG. 5D, and also provides the price range, shipping information, a date of delivery, and other product information for the Samsung® LED TV on the GUI as exemplarily illustrated in FIG. 5E, on initiation of the deal.

The reverse auction management platform acquires the deal information and the price range for the Samsung® LED TV from the lead buyer via the GUI, as exemplarily illustrated in FIG. 5E. The reverse auction management platform then examines the acquired deal information for approving the deal information. The reverse auction management platform notifies the lead buyer that a notification message, for example, an email notification, will be sent to the lead buyer on completion of events, for example, on approval of the deal information by the reverse auction management platform, addition of following buyers to the deal group, etc., as exemplarily illustrated in FIG. 5F. The reverse auction management transmits the notification message to the lead buyer, for example, via email, an SMS message, etc., when the deal is approved and finalized, when a following buyer joins the deal group, etc.

The reverse auction management platform then publishes the deal information and the price range for the deal group created for the Samsung® LED TV on the GUI of the reverse auction management platform as exemplarily illustrated in FIG. 5G. The deal information comprises, for example, an open phase time interval, an open phase expiration date, an open phase expiration time, the date of delivery, the number of buyers in the deal group, the current market price, etc. The following buyers interested in purchasing the Samsung® LED TV and who agree to the published deal information and the price range can join the deal group by clicking, for example, a “Join'em” prompt button displayed on the GUI as exemplarily illustrated in FIG. 5G. The reverse auction management platform then prompts the buyers in the deal group to input sale transaction information, for example, credit card details, a shipping address, etc., as exemplarily illustrated in FIG. 5H.

In an embodiment, the reverse auction management platform provides a user interface element on the GUI that allows the buyers in the deal group to trigger invitations to interested parties, for example, friends, etc., to join the deal group. The reverse auction management platform in communication with social networking platforms, electronic mail platforms, etc., via a network enables the buyers to invite interested parties via social networking sites, email, etc., as exemplarily illustrated in FIG. 5I. The reverse auction management platform also transmits alerts to buyers when a deal that the buyers are interested in has been initiated on the reverse auction management platform.

When the reverse auction management platform finalizes the initiated deal, the reverse auction management platform notifies the sellers of the Samsung® LED TV regarding the finalized deal, the deal information, and the price range for the Samsung® LED TV. The sellers are, for example, electronic goods outlets, showrooms, etc., offering the Samsung® LED TV. The reverse auction management platform notifies the sellers, for example, via email. The reverse auction management platform initiates bidding on the Samsung® LED TV among the sellers based on the acquired deal information and acquired the price range. For example, the bidding starts from the maximum affordable price defined by the lead buyer in the deal group and descends towards the minimum price in the price range defined by the lead buyer until the minimum price is reached, or until the bid expiration date and the bid expiration time is reached. The reverse auction management platform selects one or more sellers from the sellers of the selected sale item based on the bidding, for selling the Samsung® LED TV to the buyers in the deal group.

In an embodiment, on completion of the bidding process and selection of the sellers, the reverse auction management platform displays order details for purchase of the Samsung® LED TV to each of the buyers in the deal group, as exemplarily illustrated in FIG. 5J. Each of the buyers in the deal group can confirm the purchase of the Samsung® LED TV by clicking on a “submit order” button displayed on the GUI as exemplarily illustrated in FIG. 5J. The reverse auction management platform then generates a coupon, as exemplarily illustrated in FIG. 5K, with which the buyer can redeem the Samsung® LED TV at a store. The reverse auction management platform thereby manages the collective purchase of the Samsung® LED TV by the buyers in the deal group from the selected sellers in the interactive environment.

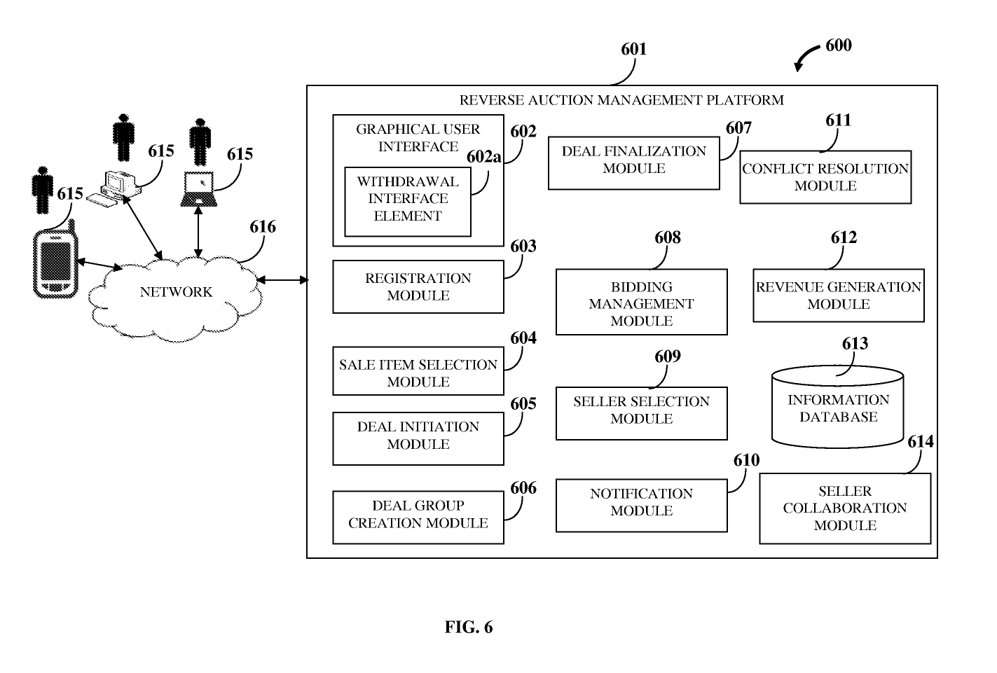

FIG. 6 exemplarily illustrates a computer implemented system 600 for managing a collective purchase of a sale item in an interactive environment. The computer implemented system 600 disclosed herein comprises a reverse auction management platform 601 accessible to a computing device 615 of each of multiple buyers and sellers in the interactive environment over a network 616. The network 616 is, for example, the internet, an intranet, a local area network, a wide area network, a communication network implementing Wi-Fi® of the Wireless Ethernet Compatibility Alliance, Inc., a cellular network, a mobile communication network, etc. The reverse auction management platform 601 comprises at least one processor configured to execute modules 602, 603, 604, 605, 606, 607, 608, 609, 610, 611, 612, 613, and 614 of the reverse auction management platform 601. The reverse auction management platform 601 comprises a graphical user interface (GUI) 602, a sale item selection module 604, a deal initiation module 605, a deal group creation module 606, a deal finalization module 607, a bidding management module 608, a seller selection module 609, a notification module 610, a conflict resolution module 611, a revenue generation module 612, and an information database 613. The GUI 602 comprises, for example, a set of a web pages hosted on a server associated with the reverse auction management platform 601.

In an embodiment, the reverse auction management platform 601 further comprises a registration module 603 for registering the buyers and the sellers with the reverse auction management platform 601. In an embodiment, the registration module 603 records the first buyer who registers with the reverse auction management platform 601 for initiation of a deal as the lead buyer. In an embodiment, the registration module 603 provides an option to buyers to register with the reverse auction management platform 601 via a third party account, as exemplarily illustrated in FIG. 5A. For example, the lead buyer can register with the reverse auction management platform 601 via the lead buyer's Facebook® account maintained by Facebook, Inc.

The information database 613 stores a list of sale items, information of deals initiated on the reverse auction management platform 601, sale transaction information of each of the buyers in a deal group, information of each of the buyers and sellers registered with the reverse auction management platform 601, etc. The sale item selection module 604 retrieves the list of sale items from the information database 613 and displays the sale items to the user via the GUI 602. The sale item selection module 604 acquires an indication of a sale item selected from multiple sale items displayed on the reverse auction management platform 601 by a lead buyer via the GUI 602 of the reverse auction management platform 601.

The deal initiation module 605 initiates a deal for the selected sale item on the reverse auction management platform 601 based on an input received from the lead buyer. In an embodiment, the deal initiation module 605 determines whether a deal has already been initiated for the selected sale item. The deal initiation module 605 acquires a price range for the selected sale item and deal information comprising, for example, an open phase time interval, an open phase expiration date, an open phase expiration time, a date and a time for delivery of the selected sale item to each of the buyers in the deal group, conditional criteria defined by the lead buyer, etc., from the lead buyer via the GUI 602 on the initiation of the deal. In an embodiment, the deal initiation module 605 acquires the price range defined by the lead buyer for the selected sale item on the GUI 602 based on an agreement by one or more sellers of the selected sale item to supply the selected sale item for a price within the price range.

In an embodiment, the deal initiation module 605 selects the price range for the deal group based on a price range associated with one or more prior transactions involving the same or a similar type of the selected sale item. Furthermore, in an embodiment, the deal initiation module 605 generates recommendations for setting a price range, that is, a minimum price and a maximum price, based on the current market price of the selected sale item, as disclosed in the detailed description of FIG. 1.

The deal group creation module 606 creates a deal group comprising the lead buyer and one or more following buyers for the selected sale item based on the acquired deal information and the acquired price range. In addition to the lead buyer, the deal group creation module 606 adds one or more following buyers to the deal group who agree to the deal information and the price range acquired from the lead buyer for the selected sale item. In an embodiment, the deal group creation module 606 generates and transmits invitations to one or more prospective following buyers associated with the lead buyer on one or more social networking platforms for joining the deal group via the network 616. Furthermore, after initiation of a deal by a lead buyer on the reverse auction management platform 601, the deal group creation module 606 allows the lead buyer to share links of the deal, for example, on the lead buyer's wall application on Facebook for inviting the lead buyer's friends to join the deal group.

The deal finalization module 607 finalizes the initiated deal for the selected sale item based on the deal finalization criteria comprising, for example, a completion of an open phase time interval during which one or more following buyers agree to purchase the selected sale item in accordance with conditional criteria defined by the lead buyer for the collective purchase of the selected sale item, reaching of a maximum number of following buyers allowed in the deal group, etc., when one or more following buyers agree to the deal information and the price range acquired from the lead buyer.

Furthermore, the deal finalization module 607 acquires and validates sale transaction information from the lead buyer and each of the following buyers in the deal group, for example, at a point in time at initiation of the open phase, a point in time during the open phase, or at a point in time at expiration of the open phase via the GUI 602, for facilitating the collective purchase of the selected sale item. The deal finalization module 607 obtains a legally binding confirmation from the lead buyer and each of the following buyers in the deal group regarding the collective purchase of the selected sale item prior to expiration of the open phase via the GUI 602.

In an embodiment, the GUI 602 comprises a withdrawal interface element 602a for allowing the lead buyer and/or any of the following buyers to withdraw from the deal group during the open phase. In an embodiment, the deal finalization module 607 determines a penalty for withdrawal of the lead buyer and/or any of the following buyers from the deal group after expiration of the open phase. In another embodiment, the deal finalization module 607 does not permit the withdrawal from the deal group after the expiration of the open phase, or requests the buyer to forfeit the entire price of the sale item. The notification module 610 transmits a notification to each of the sellers of the selected sale item, the lead buyer, and each of the following buyers in the deal group regarding the finalized deal for the selected sale item via the network 616.

The bidding management module 608 initiates bidding on the selected sale item among the sellers of the selected sale item in the interactive environment based on the acquired deal information for the selected sale item, the acquired price range for the selected sale item, and the finalized deal. In an embodiment, the bidding management module 608 initiates a bidding interval for the bidding on the selected sale item among the sellers of the selected sale item after the open phase during which the following buyers agree to purchase the selected sale item in accordance with conditional criteria defined by the lead buyer for the collective purchase of the selected sale item. The bidding management module 608 terminates the bidding on the selected sale item when any of the sellers of the selected sale item agrees to supply the selected sale item to the lead buyer and each of the following buyers in the deal group at the minimum price of the selected sale item. The seller selection module 609 selects one or more of the sellers based on the bidding and/or predetermined seller selection criteria for supplying the selected sale item to the lead buyer and each of the following buyers in the deal group for a price within the acquired price range as disclosed in the detailed description of FIG. 1.

In an embodiment, the reverse auction management platform 601 further comprises a seller collaboration module 614 that enables multiple sellers to form a consortium, collaborate, and collectively deliver the selected sale item to the buyers in the deal group in accordance with the deal information and the price range.

The conflict resolution module 611 of the reverse auction management platform 601 defines conflict resolution criteria agreeable to the lead buyer and each of the following buyers in the deal group and the sellers of the selected sale item for resolving conflicts between the lead buyer and each of the following buyers in the deal group and the sellers of the selected sale item.

In an embodiment, the deal initiation module 605 acquires modifications to the deal information and/or the price range for the selected sale item from the lead buyer via the GUI 602 of the reverse auction management platform 601 for facilitating a renewed bidding on the selected sale item by the sellers of the selected sale item in the interactive environment on failure of the initiated bidding.

The revenue generation module 612 of the reverse auction management platform 601, in communication with the deal finalization module 607, generates revenue by charging a predetermined commission from the lead buyer and each of the following buyers in the deal group and each of the selected sellers of the selected sale item on finalization of the initiated deal and supply of the selected sale item to the lead buyer and each of the following buyers in the deal group.

In an embodiment, the notification module 610 transmits notifications on supplementary sale items associated with the selected sale item to the lead buyer, each of the following buyers in the deal group, and other buyers via the network 616 for initiating another deal on the reverse auction management platform 601.

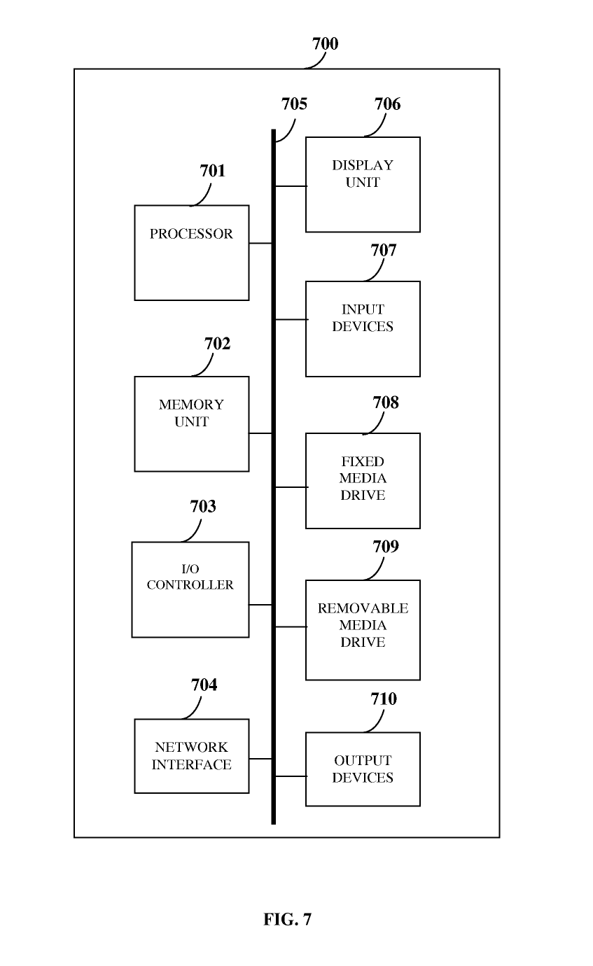

FIG. 7 exemplarily illustrates the architecture of a computer system 700 employed by the reverse auction management platform 601 for managing a collective purchase of a sale item in an interactive environment. The reverse auction management platform 601 of the computer implemented system 600 exemplarily illustrated in FIG. 6 employs the architecture of the computer system 700 exemplarily illustrated in FIG. 7.

The reverse auction management platform 601 communicates with the computing devices 615 of the buyers and the sellers as exemplarily illustrated in FIG. 6, via the network 616, for example, a short range network or a long range network. The computing device 615 is, for example, a desktop computer, a laptop computer, a cellular phone, a smart phone, a tablet computer, etc. The network 616 is, for example, the internet, a local area network, a wide area network, a wireless network, a mobile communication network, etc. The computer system 700 comprises a processor 701, a memory unit 702 for storing programs and data, an input/output (I/O) controller 703, a network interface 704, a data bus 705, a display unit 706, input devices 707, a fixed media drive 708, a removable media drive 709 for receiving removable media, output devices 710, etc.

The processor 701 is an electronic circuit that executes computer programs. The memory unit 702 is used for storing programs, applications, and data. For example, the registration module 603, the sale item selection module 604, the deal initiation module 605, the deal group creation module 606, the deal finalization module 607, the bidding management module 608, the seller selection module 609, the notification module 610, the conflict resolution module 611, the revenue generation module 612, the seller collaboration module 614, etc., of the reverse auction management platform 601 exemplarily illustrated in FIG. 6, are stored in the memory unit 702 of the computer system 700 of the reverse auction management platform 601. The memory unit 702 is, for example, a random access memory (RAM) or another type of dynamic storage device that stores information and instructions for execution by the processor 701. The memory unit 702 also stores temporary variables and other intermediate information used during execution of the instructions by the processor 701. The computer system 700 further comprises a read only memory (ROM) or another type of static storage device that stores static information and instructions for the processor 701.

The network interface 704 enables connection of the computer system 700 to the network 616. For example, the reverse auction management platform 601 connects to the network 616 via the network interface 704. The network interface 704 comprises, for example, an infrared (IR) interface, an interface implementing WiFi® of the Wireless Ethernet Compatibility Alliance, Inc., a universal serial bus (USB) interface, a local area network (LAN) interface, a wide area network (WAN) interface, etc. The I/O controller 703 controls input actions and output actions performed by the reverse auction management platform 601. The data bus 705 permits communications between the modules, for example, 603, 604, 605, 606, 607, 608, 609, 610, 611, 612, 614, etc., of the reverse auction management platform 601.

The display unit 706 of the reverse auction management platform 601, via the GUI 602, displays information, for example, display interfaces, icons, user interface elements such as text fields, checkboxes, etc., for entering a price range and deal information by a lead buyer, sale transaction information by each of the buyers, a number of buyers in the deal group, an open phase time interval defined for the deal, etc. The input devices 707 are used for inputting data into the computer system 700. The buyers and/or the sellers of the selected sale item use the input devices 707 of their computing devices 615 to provide inputs to the reverse auction management platform 601. For example, a lead buyer may initiate a deal, provide inputs on deal information and a price range for the initiated deal, enter sale transaction information, etc., using the input devices 707. A buyer in the deal group may withdraw from the deal group during the open phase by clicking on the withdraw interface element 602a on the GUI 602 of the reverse auction management platform 601 using the input devices 707. The input devices 707 are, for example, a keyboard such as an alphanumeric keyboard, a joystick, a pointing device such as a computer mouse, a touch pad, a light pen, etc.

The output devices 710 output the results of operations performed by the reverse auction management platform 601. For example, the reverse auction management platform 601 displays an amount of time left for closure of a deal, an open phase time interval, a list of one or more sellers selected to supply the selected sale item to each of the buyers in a deal group, etc., using the output devices 710. The reverse auction management platform 601 displays a pop-up window on the GUI 602 indicating, for example, the expiration of the open phase, an addition of a new following buyer to the deal group, etc.

Computer applications and programs are used for operating the computer system 700. The programs are loaded onto the fixed media drive 708 and into the memory unit 702 of the computer system 700 via the removable media drive 709. In an embodiment, the computer applications and programs may be loaded directly via the network 616. Computer applications and programs are executed by double clicking a related icon displayed on the display unit 706 using one of the input devices 707.

The computer system 700 employs an operating system for performing multiple tasks. The operating system is responsible for management and coordination of activities, and sharing of resources of the computer system 700. The operating system further manages security of the computer system 700, peripheral devices connected to the computer system 700, and network connections. The operating system employed on the computer system 700 recognizes, for example, inputs provided by the buyers and the sellers using one of the input devices 707, the output display, files, and directories stored locally on the fixed media drive 708, for example, a hard drive. The operating system on the computer system 700 executes different programs using the processor 701. The processor 701 retrieves instructions for executing the modules, for example, 603, 604, 605, 606, 607, 608, 609, 610, 611, 612, 614, etc., of the reverse auction management platform 601 from the memory unit 702. A program counter determines the location of the instructions in the memory unit 702. The program counter stores a number that identifies the current position in the program of each of the modules, for example, 603, 604, 605, 606, 607, 608, 609, 610, 611, 612, 614, etc., of the reverse auction management platform 601.

The instructions fetched by the processor 701 from the memory unit 702 after being processed are decoded. The instructions are stored in an instruction register in the processor 701. After processing and decoding, the processor 701 executes the instructions. For example, the registration module 603 defines instructions for registering the buyers and the sellers with the reverse auction management platform 601. The sale item selection module 604 defines instructions for acquiring an indication of a sale item selected from multiple sale items displayed on the reverse auction management platform 601 by a lead buyer, via the GUI 602 of the reverse auction management platform 601. The deal initiation module 605 defines instructions for initiating a deal for the selected sale item on the reverse auction management platform 601 based on an input received from the lead buyer via the GUI 602. The deal initiation module 605 defines instructions for acquiring deal information and a price range for the selected sale item from the lead buyer via the GUI 602 on initiation of the deal. The deal initiation module 605 defines instructions for acquiring the price range defined by the lead buyer for the selected sale item on the GUI 602 based on an agreement by one or more of the sellers to supply the selected sale item for a price within the price range.

Furthermore, the deal initiation module 605 defines instructions for selecting the price range for the deal group based on a price range associated with one or more prior transactions involving the same or a similar type of the selected sale item. The deal group creation module 606 defines instructions for creating a deal group comprising the lead buyer and one or more following buyers for the selected sale item based on the acquired deal information and the acquired price range. The deal group creation module 606 defines instructions for generating and transmitting invitations to one or more prospective following buyers associated with the lead buyer on one or more social networking platforms for joining the deal group, via the network 616.

The deal finalization module 607 defines instructions for finalizing the initiated deal for the selected sale item based on the deal finalization criteria, when one or more following buyers agree to the deal information and the price range acquired from the lead buyer. Furthermore, the deal finalization module 607 defines instructions for acquiring and validating sale transaction information from the lead buyer and each of the following buyers in the deal group, for example, at a point in time at initiation of an open phase, at a point in time during the open phase, or at a point in time at expiration of the open phase via the GUI 602 for facilitating the collective purchase of the selected sale item. The deal finalization module 607 defines instructions for obtaining a legally binding confirmation from the lead buyer and each of the following buyers in the deal group regarding the collective purchase of the selected sale item prior to expiration of the open phase via the GUI 602. The deal finalization module 607 defines instructions for determining a penalty for withdrawal of the lead buyer and any of the following buyers from the deal group after expiration of the open phase. The notification module 610 defines instructions for transmitting a notification to each of the sellers of the selected sale item, the lead buyer, and each of the following buyers in the deal group regarding the finalized deal for the selected sale item via the network 616.

The bidding management module 608 defines instructions for initiating bidding on the selected sale item among the sellers of the selected sale item in the interactive environment based on the acquired deal information for the selected sale item, the acquired price range for the selected sale item, and the finalized deal. The bidding management module 608 defines instructions for initiating a bidding interval for the bidding on the selected sale item among the sellers of the selected sale item after the open phase during which the following buyers agree to purchase the selected sale item in accordance with conditional criteria defined by the lead buyer for the collective purchase of the selected sale item. The bidding management module 608 defines instructions for terminating the bidding on the selected sale item when any of the sellers of the selected sale item agrees to supply the selected sale item to the lead buyer and each of the following buyers in the deal group at the minimum price of the selected sale item. The deal initiation module 605 defines instructions for acquiring modifications to the deal information and the price range for the selected sale item from the lead buyer via the GUI 602 for facilitating a renewed bidding on the selected sale item by the sellers of the selected sale item in the interactive environment on failure of the initiated bidding.

The seller selection module 609 defines instructions for selecting one or more of the sellers based on the bidding and/or the predetermined seller selection criteria for supplying the selected sale item to the lead buyer and each of the following buyers in the deal group for a price within the acquired price range. The notification module 610 defines instructions for transmitting notifications on supplementary sale items associated with the selected sale item to the lead buyer, each of the following buyers in the deal group, and other buyers via the network 616 for initiating another deal on the reverse auction management platform 601. The seller collaboration module 614 defines instructions for enabling multiple sellers to form a consortium, collaborate, and collectively deliver the selected sale item to the buyers in the deal group in accordance with the deal information and the price range.

The conflict resolution module 611 defines instructions for defining conflict resolution criteria agreeable to the lead buyer and each of the following buyers in the deal group and the sellers of the selected sale item for resolving conflicts between the lead buyer and each of the following buyers in the deal group and the sellers of the selected sale item. The revenue generation module 612 defines instructions for generating revenue by charging a predetermined commission from the lead buyer and each of the following buyers in the deal group and each of the selected sellers of the selected sale item on finalization of the initiated deal and supply of the selected sale item to the lead buyer and each of the following buyers in the deal group.

The processor 701 of the computer system 700 employed by the reverse auction management platform 601 retrieves the instructions defined by the registration module 603, the sale item selection module 604, the deal initiation module 605, the deal group creation module 606, the deal finalization module 607, the bidding management module 608, the seller selection module 609, the notification module 610, the conflict resolution module 611, the revenue generation module 612, and the seller collaboration module 614 of the reverse auction management platform 601 and executes the instructions.

At the time of execution, the instructions stored in the instruction register are examined to determine the operations to be performed. The processor 701 then performs the specified operations. The operations comprise arithmetic operations and logic operations. The operating system performs multiple routines for performing a number of tasks required to assign the input devices 707, the output devices 710, and memory for execution of the modules, for example, 603, 604, 605, 606, 607, 608, 609, 610, 611, 612, 614, etc., of the reverse auction management platform 601. The tasks performed by the operating system comprise, for example, assigning memory to the modules, for example, 603, 604, 605, 606, 607, 608, 609, 610, 611, 612, 614, etc., of the reverse auction management platform 601, and to data used by the reverse auction management platform 601, moving data between the memory unit 702 and disk units, and handling input/output operations. The operating system performs the tasks on request by the operations and after performing the tasks, the operating system transfers the execution control back to the processor 701. The processor 701 continues the execution to obtain one or more outputs. The outputs of the execution of the modules, for example, 603, 604, 605, 606, 607, 608, 609, 610, 611, 612, 614, etc., of the reverse auction management platform 601 are displayed to the user on the display unit 706.

For purposes of illustration, the detailed description refers to the reverse auction management platform 601 being run locally on a computer system 700; however the scope of the computer implemented method and system 600 disclosed herein is not limited to the reverse auction management platform 601 being run locally on the computer system 700 via the operating system and the processor 701, but may be extended to run remotely over the network 616 by employing a web browser and a remote server, a mobile phone, or other electronic devices.

Disclosed herein is also a computer program product comprising a non-transitory computer readable storage medium that stores computer program codes comprising instructions executable by at least one processor 701 for managing a collective purchase of a sale item in an interactive environment. As used herein, the term “non-transitory computer readable storage medium” refers to all computer readable media, for example, non-volatile media such as optical disks or magnetic disks, volatile media such as a register memory, a processor cache, etc., and transmission media such as wires that constitute a system bus coupled to the processor 701, except for a transitory, propagating signal. The computer program codes comprise a first computer program code for providing a GUI 602 configured to allow selection of a sale item from multiple sale items displayed on the reverse auction management platform 601 by a lead buyer from multiple buyers; a second computer program code for initiating a deal for the selected sale item on the reverse auction management platform 601 based on inputs received from the lead buyer via the GUI 602; a third computer program code for acquiring deal information and a price range for the selected sale item from the lead buyer via the GUI 602 on initiation of the deal, a fourth computer program code for creating a deal group comprising the lead buyer and one or more following buyers for the selected sale item based on the acquired deal information and the acquired price range; a fifth computer program code for finalizing the initiated deal for the selected sale item based on deal finalization criteria when the following buyers agree to the deal information and the price range acquired from the lead buyer; a sixth computer program code for initiating bidding on the selected sale item among the sellers of the selected sale item in the interactive environment based on the acquired deal information, the acquired price range for the selected sale item, and the finalized deal; and a seventh computer program code for selecting one or more of the sellers based on the bidding and/or the predetermined seller selection criteria, for supplying the selected sale item to the lead buyer and each of the following buyers in the deal group for a price within the acquired price range. The computer program product disclosed herein further comprises one or more additional computer program codes for performing additional steps that may be required and contemplated for managing a collective purchase of a sale item in an interactive environment. In an embodiment, a single piece of computer program code comprising computer executable instructions performs one or more steps of the computer implemented method disclosed herein for managing a collective purchase of a sale item in an interactive environment.

The computer program codes comprising computer executable instructions are embodied on the non-transitory computer readable storage medium. The processor 701 of the computer system 700 retrieves these computer executable instructions and executes them. When the computer executable instructions are executed by the processor 701, the computer executable instructions cause the processor 701 to perform the steps of the computer implemented method for managing a collective purchase of a sale item in an interactive environment.

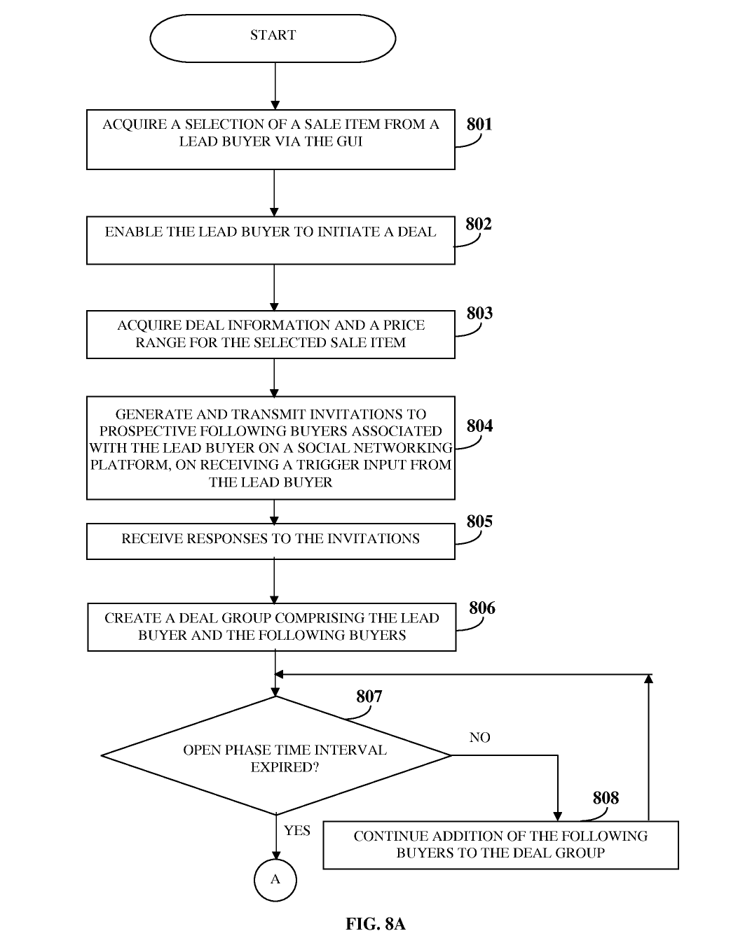

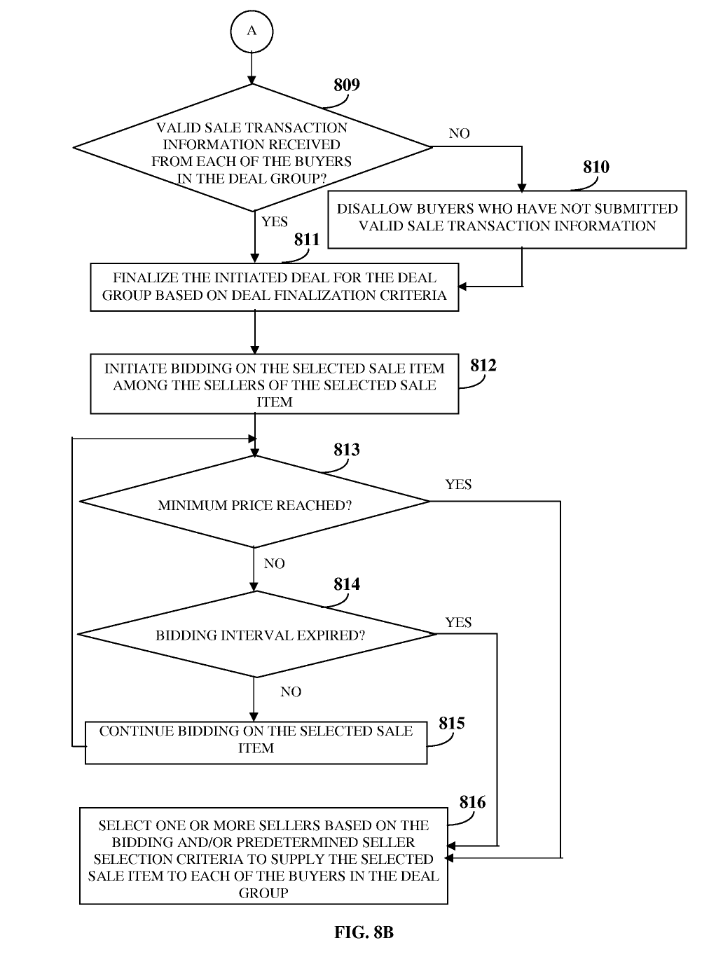

FIGS. 8A-8B exemplarily illustrate a flowchart comprising the steps performed by the reverse auction management platform 601 exemplarily illustrated in FIG. 6, for managing a collective purchase of a sale item in an interactive environment. Consider an example where a user Alex accesses the reverse auction management platform 601 for purchasing a sale item, for example, a washing machine. The reverse auction management platform 601 displays a catalogue of washing machines available for bidding in a reverse auction on the graphical user interface (GUI) 602. The reverse auction management platform 601 acquires 801 a selection of the sale item of a particular brand and model of the washing machine from Alex via the GUI 602. The reverse auction management platform 601 determines that no deal has been initiated yet for that particular sale item, that is, the washing machine. The reverse auction management platform 601 notifies Alex that no deal has been initiated for the washing machine and that Alex could be the lead buyer for a new deal. The reverse auction management platform 601 prompts the lead buyer Alex to initiate a new deal for the washing machine. The reverse auction management platform 601 provides a “create your deal” button on the GUI 602 as exemplarily illustrated in FIGS. 2A-2B and FIGS. 5C-5J, that enables 802 the lead buyer Alex to initiate a deal. Since Alex is the lead buyer for the deal, the reverse auction management platform 601 allows Alex to set condition criteria, a price range, etc., for the deal.

The reverse auction management platform 601 acquires 803 deal information and a price range for the selected sale item, that is, the washing machine, from Alex, via the GUI 602. The reverse auction management platform 601 acquires, for example, the open phase time interval for the deal, a maximum price and a minimum price for the washing machine, a date and a time within which the washing machine needs to be delivered, etc., from Alex.

In order to create a deal group, the reverse auction management platform 601 prompts the lead buyer Alex to invite following buyers to be a part of the initiated deal. In this example, the lead buyer Alex invites his friends on a social networking platform to be a part of the deal. Alex enters the contact details, for example, electronic mail (email) addresses, account details associated with the social networking platform, etc., of each of the prospective following buyers via the GUI 602. On receiving a trigger input from the lead buyer Alex, the reverse auction management platform 601 generates 804 invitations for each of the prospective following buyers associated with the lead buyer Alex on the social networking platform and transmits 804 the invitations to the prospective following buyers, for example, via emails, messages, etc. The invitations comprise a description of the price range, the deal information, conditional criteria, etc., defined by the lead buyer Alex. The reverse auction management platform 601 receives 805 responses to the invitations from each of the prospective following buyers. If the response is an acceptance of the deal, the reverse auction management platform 601 determines that the prospective following buyer has agreed to the terms and conditions defined for the initiated deal. Therefore, the reverse auction management platform 601 records each of these buyers as following buyers for the deal.

The reverse auction management platform 601 creates 806 a deal group comprising the lead buyer Alex and each of the following buyers. Further, the reverse auction management platform 601 acquires sale transaction information from each of the buyers in the deal group via the GUI 602. The sale transaction information comprises the payment transaction information and the contact details such as the shipping address of each of the buyers in the deal group. The reverse auction management platform 601 determines 807 whether the open phase defined by the lead buyer Alex for the deal has expired. The open phase indicates the amount of time that the deal remains open, that is, the amount of time that the deal is available to a following buyer for joining the deal group. If the open phase has not expired yet, the reverse auction management platform 601 continues 808 to add more following buyers who have accepted the price range and the deal information defined by the lead buyer, to the deal group. The reverse auction management platform 601 then returns to determine whether the open phase has expired 807. Further, the reverse auction management platform 601 acquires the sale transaction information from each of the following buyers via the GUI 602. If the open phase has expired, the reverse auction management platform 601 extracts the payment transaction information from the sale transaction information provided by each of the buyers in the deal group. The reverse auction management platform 601 then determines 809 whether valid sale transaction information, for example, payment information has been received from each of the buyers in the created deal group. If valid sale transaction information has not been received from one or more buyers in the deal group, the reverse auction management platform 601 disallows 810 these buyers from purchasing the selected washing machine at a reduced price on completion of the bidding process. The reverse auction management platform 601 then proceeds with the next set of steps 811 and 812 for initiating the bidding process.

If valid sale transaction information has been received from each of the buyers in the deal group, the reverse auction management platform 601 finalizes 811 the initiated deal for the deal group based on deal finalization criteria. In this example, the deal finalization criterion is the presence of at least one buyer in the deal group who has submitted valid payment transaction information at a point of time of completion of the open phase. In this example, since the open phase has been completed and there is at least one buyer in the deal group who has submitted valid payment transaction information, the reverse auction management platform 601 finalizes the initiated deal. The reverse auction management platform 601 transmits a notification to each of the buyers in the deal group and the sellers of the selected washing machine via an email, a short message service (SMS) message, etc., regarding the finalized deal.

The reverse auction management platform 601 then obtains a list of sellers who have agreed to supply the selected sale item, that is, the washing machine, to the buyers in the deal group at a price within the price range defined by the lead buyer Alex. The reverse auction management platform 601 initiates 812 bidding on the selected sale item, that is, the washing machine among the sellers of the washing machine. The initial bidding price is set equal to the maximum price in the price range defined by the lead buyer. In an embodiment, the reverse auction management platform 601 reduces the bidding price in fixed decrements starting from the maximum price in the price range towards the minimum price. The reverse auction management platform 601 then determines for each bidding price, the number of sellers who agree to supply the washing machine at that price. The reverse auction management platform 601 monitors the bidding price periodically to determine 813 whether the bidding price has reached the minimum price in the price range. In an embodiment, any registered seller is allowed to submit a bid which has to be lower than the previously lowest bid. Bidding continues until either the bidding interval expires, or one of the sellers bids the minimum price. At that point, the seller with the lowest bid is deemed to be the winning bidder. In this model, the reverse auction management platform 601 precludes the existence of more than one seller with the lowest bid, because the reverse auction management platform 601 does not allow the sellers to bid the same price as another bidder.

If the bidding price has reached the minimum price, the reverse auction management platform 601 terminates the bidding and determines whether there are one or more sellers who have agreed to supply the washing machine at the minimum price in the price range. If there is more than one seller who agrees to supply the selected washing machine at the minimum price defined by the price range, the reverse auction management platform 601 selects 816 one or more sellers to supply the selected washing machine to each of the buyers in the deal group based on the bidding and/or the predetermined seller selection criteria. Consider an example where there are two sellers who have agreed to supply the selected washing machine at the same price. The reverse auction management platform 601 selects both the sellers for supplying washing machines to the buyers in the deal group; however, the reverse auction management platform 601 divides the number of buyers to whom the sellers can supply the selected washing machine, for example, based on the geographical proximity of a particular seller to a buyer in the deal group. Therefore, in this example, the predetermined seller selection criterion comprises the geographical proximity of the seller to a particular buyer in the deal group.

If the bidding price at the end of the period of monitoring of the bidding has not reached the minimum price, the reverse auction management platform 601 determines 814 whether the bidding interval has expired. That is, the reverse auction management platform 601 determines whether a bid expiration date and a bid expiration time have been reached. If the bidding interval has not expired, the reverse auction management platform 601 allows the sellers to continue 815 bidding on the selected sale item, that is, the washing machine for supplying the selected washing machine at a price within the price range and returns to determine whether 813 the minimum price has been reached. If the bidding interval has expired, the reverse auction management platform 601 then determines the lowest price reached by one or more sellers that may or may not have reached the minimum price set in the price range. If the minimum price has been reached, the reverse auction management platform 601 proceeds to select 816 one or more sellers for supplying the selected sale item, that is, the washing machine to each of the buyers in the deal group. If the minimum price as defined in the price range has not yet been reached, in an embodiment, the reverse auction management platform 601 proceeds to select the seller who has bid to supply the selected washing machine to the buyers in the deal group at the lowest bid price, provided the lowest bid price is lower than the maximum price, and therefore the buyers would all be obligated to buy the product at the lowest bid price from the selected seller. In another embodiment, if the minimum price as defined in the price range has not yet been reached, the reverse auction management platform 601 queries the lead buyer in the deal group whether the buyers in the deal group intend to purchase the washing machine at the lowest price arrived within the price range at the end of the bidding interval. If the reverse auction management platform 601 determines that the buyers in the deal group would not like to purchase the washing machine at the lowest price arrived at by the sellers of the washing machine, the reverse auction management platform 601 requests the lead buyer to modify the price range and the deal information to facilitate renewed bidding. If the buyers in the deal group are ready to purchase the washing machine at the lowest price, the reverse auction management platform 601 proceeds to select the sellers who can supply the selected washing machine to the buyers in the deal group at the lowest price.

It will be readily apparent that the various methods and algorithms disclosed herein may be implemented on computer readable media appropriately programmed for general purpose computers and computing devices. As used herein, the term “computer readable media” refers to non-transitory computer readable media that participate in providing data, for example, instructions that may be read by a computer, a processor or a like device. Non-transitory computer readable media comprise all computer readable media, for example, non-volatile media, volatile media, and transmission media, except for a transitory, propagating signal. Non-volatile media comprise, for example, optical disks or magnetic disks and other persistent memory volatile media including a dynamic random access memory (DRAM), which typically constitutes a main memory. Volatile media comprise, for example, a register memory, a processor cache, a random access memory (RAM), etc. Transmission media comprise, for example, coaxial cables, copper wire and fiber optics, including wires that constitute a system bus coupled to a processor. Common forms of computer readable media comprise, for example, a floppy disk, a flexible disk, a hard disk, magnetic tape, any other magnetic medium, a compact disc-read only memory (CD-ROM), a digital versatile disc (DVD), any other optical medium, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read. A “processor” refers to any one or more microprocessors, central processing unit (CPU) devices, computing devices, microcontrollers, digital signal processors or like devices. Typically, a processor receives instructions from a memory or like device and executes those instructions, thereby performing one or more processes defined by those instructions. Further, programs that implement such methods and algorithms may be stored and transmitted using a variety of media, for example, the computer readable media in a number of manners. In an embodiment, hard-wired circuitry or custom hardware may be used in place of, or in combination with, software instructions for implementation of the processes of various embodiments. Therefore, the embodiments are not limited to any specific combination of hardware and software. In general, the computer program codes comprising computer executable instructions may be implemented in any programming language. Some examples of languages that can be used comprise C, C++, C#, Perl, Python, or JAVA. The computer program codes or software programs may be stored on or in one or more mediums as object code. The computer program product disclosed herein comprises computer executable instructions embodied in a non-transitory computer readable storage medium, wherein the computer program product comprises computer program codes for implementing the processes of various embodiments.

Where databases are described such as the information database 613, it will be understood by one of ordinary skill in the art that (i) alternative database structures to those described may be readily employed, and (ii) other memory structures besides databases may be readily employed. Any illustrations or descriptions of any sample databases disclosed herein are illustrative arrangements for stored representations of information. Any number of other arrangements may be employed besides those suggested by tables illustrated in the drawings or elsewhere. Similarly, any illustrated entries of the databases represent exemplary information only; one of ordinary skill in the art will understand that the number and content of the entries can be different from those disclosed herein. Further, despite any depiction of the databases as tables, other formats including relational databases, object-based models, and/or distributed databases may be used to store and manipulate the data types disclosed herein. Likewise, object methods or behaviors of a database can be used to implement various processes such as those disclosed herein. In addition, the databases may, in a known manner, be stored locally or remotely from a device that accesses data in such a database. In embodiments where there are multiple databases in the system, the databases may be integrated to communicate with each other for enabling simultaneous updates of data linked across the databases, when there are any updates to the data in one of the databases.

The present invention can be configured to work in a network environment including a computer that is in communication with one or more devices via a network. The computer may communicate with the devices directly or indirectly, via a wired medium or a wireless medium such as the Internet, a local area network (LAN), a wide area network (WAN) or the Ethernet, token ring, or via any appropriate communications means or combination of communications means. Each of the devices may comprise computers such as those based on the Intel® processors, AMD® processors, UltraSPARC® processors, IBM® processors, etc., that are adapted to communicate with the computer. Any number and type of machines may be in communication with the computer.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

We claim:

1. A computer implemented method for managing a collective purchase of a sale item in an interactive environment, comprising:
providing a reverse auction management platform comprising at least one processor configured to manage said collective purchase of said sale item in said interactive environment, wherein said reverse auction management platform is accessible by a computing device of each of a plurality of buyers and sellers in said interactive environment over a network;
selecting said sale item from a plurality of sale items displayed on said reverse auction management platform by a lead buyer from said buyers via a graphical user interface provided by said reverse auction management platform;
initiating a deal for said selected sale item on said reverse auction management platform by said lead buyer via said graphical user interface;
acquiring deal information and a price range for said selected sale item from said lead buyer by said reverse auction management platform via said graphical user interface on said initiation of said deal;
creating a deal group comprising said lead buyer and one or more following buyers for said selected sale item by said reverse auction management platform based on said acquired deal information and said acquired price range;
finalizing said initiated deal for said selected sale item by said reverse auction management platform based on deal finalization criteria, when said one or more following buyers agree to said deal information and said price range acquired from said lead buyer;
initiating bidding on said selected sale item among said sellers of said selected sale item by said reverse auction management platform in said interactive environment based on said acquired deal information, said acquired price range for said selected sale item, and said finalized deal; and
selecting one or more of said sellers by said reverse auction management platform based on one or more of said bidding and predetermined seller selection criteria, for supplying said selected sale item to said lead buyer and each of said one or more following buyers in said deal group for a price within said acquired price range;
whereby said reverse auction management platform manages said collective purchase of said selected sale item by said lead buyer and said one or more following buyers in said deal group from said selected one or more of said sellers in said interactive environment.

2. The computer implemented method of claim 1, wherein said deal finalization criteria comprise one or more of a completion of an open phase time interval during which said one or more following buyers agree to purchase said selected sale item in accordance with conditional criteria defined by said lead buyer for said collective purchase of said selected sale item, and reaching of a maximum number of said one or more following buyers allowed in said deal group.

3. The computer implemented method of claim 2, further comprising initiating a bidding interval for said bidding on said selected sale item among said sellers of said selected sale item by said reverse auction management platform after said completion of said open phase time interval.

4. The computer implemented method of claim 1, wherein said deal information comprises an open phase time interval, an open phase expiration date, an open phase expiration time, a date and a time for delivery of said selected sale item to said lead buyer and said one or more following buyers in said deal group, and conditional criteria, defined by said lead buyer via said graphical user interface.

5. The computer implemented method of claim 1, wherein said acquired price range comprises a minimum price and a maximum price for said selected sale item.

6. The computer implemented method of claim 1, wherein said lead buyer defines said price range for said selected sale item on said graphical user interface of said reverse auction management platform based on an agreement by one or more of said sellers of said selected sale item to supply said selected sale item for a price within said price range.

7. The computer implemented method of claim 1, further comprising selecting said price range for said deal group by said reverse auction management platform based on a price range associated with one or more prior transactions involving one of a same type of said selected sale item and a similar type of said selected sale item.

8. The computer implemented method of claim 1, further comprising transmitting a notification to each of said sellers of said selected sale item, said lead buyer, and each of said one or more following buyers in said deal group regarding said finalized deal for said selected sale item by said reverse auction management platform via said network.

9. The computer implemented method of claim 1, further comprising acquiring modifications to one or more of said deal information and said price range for said selected sale item from said lead buyer via said graphical user interface of said reverse auction management platform for facilitating a renewed bidding on said selected sale item by said sellers of said selected sale item in said interactive environment, by said reverse auction management platform on failure of said initiated bidding.

10. The computer implemented method of claim 1, further comprising providing a withdrawal interface element on said graphical user interface by said reverse auction management platform for allowing one or more of said lead buyer and any of said one or more following buyers to withdraw from said deal group during an open phase time interval, wherein said open phase time interval is a time interval during which said one or more following buyers agree to purchase said selected sale item in accordance with conditional criteria defined by said lead buyer for said collective purchase of said selected sale item.

11. The computer implemented method of claim 10, further comprising determining a penalty for said withdrawal of said one or more of said lead buyer and said any of said one or more following buyers from said deal group by said reverse auction management platform after expiration of said open phase time interval.

12. The computer implemented method of claim 1, further comprising acquiring and validating sale transaction information from said lead buyer and each of said one or more following buyers in said deal group at one of a point in time at initiation of an open phase time interval, a point in time during said open phase time interval, and a point in time at expiration of said open phase time interval by said reverse auction management platform via said graphical user interface, for facilitating said collective purchase of said selected sale item, wherein said open phase time interval is a time interval during which said one or more following buyers agree to purchase said selected sale item in accordance with conditional criteria defined by said lead buyer for said collective purchase of said selected sale item.

13. The computer implemented method of claim 1, further comprising obtaining a legally binding confirmation from said lead buyer and each of said one or more following buyers in said deal group regarding said collective purchase of said selected sale item prior to expiration of an open phase time interval by said reverse auction management platform via said graphical user interface, wherein said open phase time interval is a time interval during which said one or more following buyers agree to purchase said selected sale item in accordance with conditional criteria defined by said lead buyer for said collective purchase of said selected sale item.

14. The computer implemented method of claim 1, further comprising removing one or more of said one or more following buyers from said deal group by said reverse auction management platform, if said one or more of said one or more following buyers have not provided valid sale transaction information to said reverse auction management platform prior to said expiration of an open phase time interval, wherein said open phase time interval is a time interval during which said one or more following buyers agree to purchase said selected sale item in accordance with conditional criteria defined by said lead buyer for said collective purchase of said selected sale item.

15. The computer implemented method of claim 1, further comprising terminating said bidding on said selected sale item by said reverse auction management platform when any of said sellers of said selected sale item agrees to supply said selected sale item to said lead buyer and said each of said one or more following buyers in said deal group at a minimum price of said selected sale item.

16. The computer implemented method of claim 1, wherein said predetermined seller selection criteria comprise an agreement by said one or more of said sellers to supply said selected sale item to said lead buyer and said each of said one or more buyers in said deal group.

17. The computer implemented method of claim 1, further comprising generating revenue by said reverse auction management platform by charging a predetermined commission from said lead buyer and each of said one or more following buyers in said deal group and each of said selected one or more of said sellers of said selected sale item on said finalization of said initiated deal and said supply of said selected sale item to said lead buyer and said each of said one or more following buyers in said deal group.

18. The computer implemented method of claim 1, further comprising defining conflict resolution criteria agreeable to said lead buyer and each of said one or more following buyers in said deal group and said sellers of said selected sale item by said reverse auction management platform for resolving conflicts between said lead buyer and said each of said one or more following buyers in said deal group and said sellers of said selected sale item.

19. The computer implemented method of claim 1, wherein said creation of said deal group by said reverse auction management platform comprises generating and transmitting invitations to one or more prospective following buyers associated with said lead buyer on one or more social networking platforms for joining said deal group by said reverse auction management platform, via said network.

20. The computer implemented method of claim 1, further comprising transmitting notifications on supplementary sale items associated with said selected sale item to said lead buyer, said each of said one or more following buyers in said deal group, and other said buyers by said reverse auction management platform via said network for initiating another deal on said reverse auction management platform.

21. A computer implemented system for managing a collective purchase of a sale item in an interactive environment, comprising:
a reverse auction management platform accessible to a computing device of each of a plurality of buyers and sellers in said interactive environment over a network, said reverse auction management platform comprising at least one processor configured to execute modules of said reverse auction management platform, said modules of said reverse auction management platform comprising:
a sale item selection module that acquires an indication of said sale item selected from a plurality of sale items displayed on said reverse auction management platform by a lead buyer among said buyers via a graphical user interface provided by said reverse auction management platform;
a deal initiation module that initiates a deal for said selected sale item based on an input received from said lead buyer via said graphical user interface;
said deal initiation module that acquires deal information and a price range for said selected sale item from said lead buyer via said graphical user interface on said initiation of said deal;
a deal group creation module that creates a deal group comprising said lead buyer and one or more following buyers for said selected sale item based on said acquired deal information and said acquired price range;
a deal finalization module that finalizes said initiated deal for said selected sale item based on deal finalization criteria, when said one or more following buyers agree to said deal information and said price range acquired from said lead buyer;
a bidding management module that initiates bidding on said selected sale item among said sellers of said selected sale item in said interactive environment based on said acquired deal information, said acquired price range for said selected sale item, and said finalized deal; and
a seller selection module that selects one or more of said sellers based on one or more of said bidding and predetermined seller selection criteria, for supplying said selected sale item to said lead buyer and each of said one or more following buyers in said deal group for a price within said acquired price range.

22. The computer implemented system of claim 21, wherein said deal information comprises an open phase time interval, an open phase expiration date, an open phase expiration time, a date and a time for delivery of said selected sale item to said lead buyer and said one or more following buyers in said deal group, and conditional criteria, defined by said lead buyer via said graphical user interface.

23. The computer implemented system of claim 21, wherein said deal finalization criteria comprise one or more of a completion of an open phase time interval during which said one or more following buyers agree to purchase said selected sale item in accordance with conditional criteria defined by said lead buyer for said collective purchase of said selected sale item, and reaching of a maximum number of said one or more following buyers allowed in said deal group.

24. The computer implemented system of claim 21, wherein said predetermined seller selection criteria comprise an agreement by said one or more of said sellers to supply said selected sale item to said lead buyer and said each of said one or more buyers in said deal group.

25. The computer implemented system of claim 21, wherein said bidding management module initiates a bidding interval for said bidding on said selected sale item among said sellers of said selected sale item after an open phase time interval during which said one or more following buyers agree to purchase said selected sale item in accordance with conditional criteria defined by said lead buyer for said collective purchase of said selected sale item.

26. The computer implemented system of claim 21, wherein said deal initiation module acquires said price range defined by said lead buyer for said selected sale item on said graphical user interface of said reverse auction management platform based on an agreement by one or more of said sellers of said selected sale item to supply said selected sale item for a price within said price range.

27. The computer implemented system of claim 21, wherein said deal initiation module selects said price range for said deal group based on a price range associated with one or more prior transactions involving one of a same type of said selected sale item and a similar type of said selected sale item.

28. The computer implemented system of claim 21, wherein said modules of said reverse auction management platform further comprise a notification module that transmits a notification to each of said sellers of said selected sale item, said lead buyer, and each of said one or more following buyers in said deal group regarding said finalized deal for said selected sale item via said network.

29. The computer implemented system of claim 28, wherein said notification module transmits notifications on supplementary sale items associated with said selected sale item to said lead buyer, said each of said one or more following buyers in said deal group, and other said buyers via said network for initiating another deal on said reverse auction management platform.

30. The computer implemented system of claim 21, wherein said deal initiation module acquires modifications to one or more of said deal information and said price range for said selected sale item from said lead buyer via said graphical user interface of said reverse auction management platform for facilitating a renewed bidding on said selected sale item by said sellers of said selected sale item in said interactive environment on failure of said initiated bidding.

31. The computer implemented system of claim 21, wherein said graphical user interface of said reverse auction management platform comprises a withdrawal interface element for allowing one or more of said lead buyer and any of said one or more following buyers to withdraw from said deal group during an open phase time interval, wherein said open phase time interval is a time interval during which said one or more following buyers agree to purchase said selected sale item in accordance with conditional criteria defined by said lead buyer for said collective purchase of said selected sale item.

32. The computer implemented system of claim 31, wherein said deal finalization module determines a penalty for said withdrawal of said one or more of said lead buyer and said any of said one or more following buyers from said deal group after expiration of said open phase time interval.

33. The computer implemented system of claim 21, wherein said deal finalization module acquires and validates sale transaction information from said lead buyer and each of said one or more following buyers in said deal group at one of a point in time at initiation of an open phase time interval, a point in time during said open phase time interval, and a point in time at expiration of said open phase time interval via said graphical user interface, for facilitating said collective purchase of said selected sale item, wherein said open phase time interval is a time interval during which said one or more following buyers agree to purchase said selected sale item in accordance with conditional criteria defined by said lead buyer for said collective purchase of said selected sale item.

34. The computer implemented system of claim 21, wherein said deal finalization module obtains a legally binding confirmation from said lead buyer and each of said one or more following buyers in said deal group regarding said collective purchase of said selected sale item prior to expiration of an open phase time interval via said graphical user interface, wherein said open phase time interval is a time interval during which said one or more following buyers agree to purchase said selected sale item in accordance with conditional criteria defined by the lead buyer for said collective purchase of said selected sale item.

35. The computer implemented system of claim 21, wherein said bidding management module terminates said bidding on said selected sale item when any of said sellers of said selected sale item agrees to supply said selected sale item to said lead buyer and said each of said one or more following buyers in said deal group at a minimum price of said selected sale item.

36. The computer implemented system of claim 21, wherein said modules of said reverse auction management platform further comprise a revenue generation module, in communication with said deal finalization module, that generates revenue by charging a predetermined commission from said lead buyer and each of said one or more following buyers in said deal group and each of said selected one or more of said sellers of said selected sale item on said finalization of said initiated deal and said supply of said selected sale item to said lead buyer and said each of said one or more following buyers in said deal group.

37. The computer implemented system of claim 21, wherein said modules of said reverse auction management platform further comprise a conflict resolution module that defines conflict resolution criteria agreeable to said lead buyer and each of said one or more following buyers in said deal group and said sellers of said selected sale item for resolving conflicts between said lead buyer and said each of said one or more following buyers in said deal group and said sellers of said selected sale item.

38. The computer implemented system of claim 21, wherein said deal group creation module generates and transmits invitations to one or more prospective following buyers associated with said lead buyer on one or more social networking platforms for joining said deal group, via said network.

39. A computer program product comprising a non-transitory computer readable storage medium, said non-transitory computer readable storage medium storing computer program codes that comprise instructions executable by at least one processor, said computer program codes comprising:
a first computer program code for providing a graphical user interface configured to allow selection of a sale item from a plurality of sale items displayed on a reverse auction management platform by a lead buyer from a plurality of buyers;
a second computer program code for initiating a deal for said selected sale item on said reverse auction management platform based on inputs received from said lead buyer via said graphical user interface;
a third computer program code for acquiring deal information and a price range for said selected sale item from said lead buyer via said graphical user interface on said initiation of said deal;
a fourth computer program code for creating a deal group comprising said lead buyer and one or more following buyers for said selected sale item based on said acquired deal information and said acquired price range;
a fifth computer program code for finalizing said initiated deal for said selected sale item based on deal finalization criteria, when said one or more following buyers agree to said deal information and said price range acquired from said lead buyer;
a sixth computer program code for initiating bidding on said selected sale item among said sellers of said selected sale item in said interactive environment based on said acquired deal information, said acquired price range for said selected sale item, and said finalized deal; and
a seventh computer program code for selecting one or more of said sellers based on one or more of said bidding and predetermined seller selection criteria, for supplying said selected sale item to said lead buyer and each of said one or more following buyers in said deal group for a price within said acquired price range.

40. The computer program product of claim 39, wherein said deal finalization criteria comprise one or more of a completion of an open phase time interval during which said one or more following buyers agree to purchase said selected sale item in accordance with conditional criteria defined by said lead buyer for said collective purchase of said selected sale item, and reaching of a maximum number of said one or more following buyers allowed in said deal group.
